(19) United States
(12) Patent Application Publication
(10) Pub. No.: US 2023/0034224 A1
(43) Pub. Date: Feb. 2, 2023

(54) ELECTRODE, SECONDARY BATTERY, AND ELECTRONIC DEVICE

(71) Applicant: SEMICONDUCTOR ENERGY LABORATORY CO., LTD., Atsugi-Shi, Kanagawa-Ken (JP)

(72) Inventors: Shunpei YAMAZAKI, Setagaya, Tokyo (JP); Masayuki KIMURA, Atsugi, Kanagawa (JP)

(21) Appl. No.: 17/768,909

(22) PCT Filed: Oct. 14, 2020
(86) PCT No.: PCT/IB2020/059620

§ 371 Date: Apr. 14, 2022

(30) Foreign Application Priority Data
Oct. 25, 2019 (JP) 2019-194493

(51) Int. Cl. H01M 4/583; H01M 10/0525; H01M 4/48

(52) U.S. Cl. CPC H01M 4/583; H01M 10/0525; H01M 4/483; H01M 2004/021

(57) ABSTRACT

A conductive additive a small amount of which is used for forming an active material layer with high electron conductivity is provided. An electrode for a secondary battery including a highly filled active material layer having a high density and containing a small amount of a conductive additive is provided. A secondary battery having high capacity per electrode volume is provided. The electrode includes an active material layer containing a plurality of particulate active materials and a plurality of fibrous carbon-containing compounds. Each of the carbon-containing compounds is a high molecular compound. A monomer of the high molecular compound contains at least one selected from thiophene, benzene, pyrrole, aniline, phenol, phthalocyanine, furan, azulene, and a derivative of any of these.

### TECHNICAL FIELD

One embodiment of the present invention relates to an object, a method, or a manufacturing method. One embodiment of the present invention relates to a process, a machine, manufacture, or a composition of matter. One embodiment of the present invention relates to an active material, an electrode, a positive electrode active material, a negative electrode active material, a positive electrode, and a negative electrode, which are able to be used in a secondary battery, a secondary battery, and an electronic device including a secondary battery.

### BACKGROUND ART

With the recent rapid spread of portable electronic devices such as cellular phones, smartphones, electronic books, and portable game machines, a reduction in size and an increase in capacity of secondary batteries for drive power supply have been increasingly required. Secondary batteries typified by lithium ion secondary batteries, which have advantages such as high energy density and high capacity, have been widely used as secondary batteries used for portable electronic devices.

A lithium-ion secondary battery, which is one of secondary batteries and widely used because of its high energy density, includes a positive electrode including an active material such as lithium cobalt oxide (LiCoO₂) or lithium iron phosphate (LiFePO₄), a negative electrode formed of a carbon material such as graphite capable of occlusion and release of lithium ions, a nonaqueous electrolyte solution which consists of a lithium salt such as LiBF₄ or LiPF₆ dissolved in an organic solvent such as ethylene carbonate or diethyl carbonate. The lithium-ion secondary battery is charged and discharged in such a way that lithium ions in the secondary battery move between the positive electrode and the negative electrode through the nonaqueous electrolyte solution and are inserted into or extracted from the active materials of the positive electrode and the negative electrode.

Into the positive electrode or the negative electrode, a binding agent (also referred to as a binder) is mixed in order that binding between active materials or between an active material and a current collector is made. Since the binding agent is generally an organic high molecular compound such as PVDF (polyvinylidene fluoride) which has an insulating property, the electron conductivity is extremely low. Therefore, as the ratio of the amount of the mixed binder to the amount of the active material is increased, the amount of the active material in the electrode is relatively decreased, resulting in the lower discharge capacity of the secondary battery.

Hence, by mixing a conductive additive such as acetylene black (AB) or graphite (graphite) particles, the electron conductivity between the active materials or between the active material and the current collector is improved. Thus, a positive electrode active material with high electron conductivity can be provided (see Patent Document 1).

Patent Document 2 and Non-Patent Document 1 disclose a manufacturing method of a conductive high-molecular composite.

### PRIOR ART DOCUMENT

### Patent Document

[Patent Document 1] Japanese Published Patent Application No. 2002-110162
[Patent Document 2] Japanese Published Patent Application No. 2016-62651

### Non-Patent Document

[Non-Patent Document 1] Y. Koizumi et at., “Electropolymerzation on wireless electrodes towards conducting polymer microfiber networks”, NATURE COMMUNICATIONS, 7, 10404 (2016).

### SUMMARY OF THE INVENTION

### Problems to be Solved by the Invention

An object of one embodiment of the present invention is to provide a conductive additive a small amount of which is used for forming an active material layer with high electron conductivity. Another object is to provide an electrode including a highly filled active material layer having a high density and containing a small amount of a conductive additive. Another object is to provide a battery with high capacity per electrode volume. Another object is to provide a novel material, a novel active material particle, a novel electrode, a novel secondary battery, a novel power storage device, or a manufacturing method thereof.

### Means for Solving the Problems

One embodiment of the present invention is an electrode including a current collector and an active material layer which includes a plurality of particulate active materials and a plurality of fibrous carbon-containing compounds. Each of the plurality of fibrous carbon-containing compounds is a high molecular compound. A monomer of the high molecular compound is at least one selected from the group consisting of thiophene, benzene, pyrrole, aniline, phenol, phthalocyanine, furan, azulene, and a derivative of any of these. As the carbon-containing compound of one embodiment of the present invention, a polymer whose monomer is at least one selected from the group consisting of thiophene, benzene, pyrrole, aniline, phenol, phthalocyanine, furan, azulene, and a derivative of any of these can be used.

In the above structure, the average diameter of the plurality of fibrous carbon-containing compounds is preferably greater than or equal to 0.01 μm and less than or equal to 50 μm.

In the above structure, the plurality of fibrous carbon-containing compounds preferably have a net-like structure reaching a surface of the active material layer.

In the above structure, the current collector is preferably included, the active material layer is preferably provided over the current collector, and the net-like structure is preferably in contact with a surface of the current collector.

In the above structure, the active material is preferably a lithium-containing composite oxide having an olivine crystal structure.

In the above structure, the average diameter of primary particles in the active material is preferably greater than or equal to 50 nm and less than or equal to 500 nm.

Another embodiment of the present invention is an electrode including a current collector and an active material layer which includes a plurality of particulate active materials and a plurality of fibrous carbon-containing compounds. Each of the plurality of fibrous carbon-containing compounds is a high molecular compound. A monomer of the high molecular compound is at least one selected from the group consisting of thiophene, benzene, pyrrole, aniline, phenol, phthalocyanine, furan, azulene, and a derivative of any of these. The plurality of fibrous carbon-containing compounds are in contact with each other to form a path penetrating the active material layer.

In the above structure, the average diameter of the plurality of fibrous carbon-containing compounds is preferably greater than or equal to 0.01 μm and less than or equal to 50 μm.

In the above structure, the active material is preferably a lithium-containing composite oxide having an olivine crystal structure.

In the above structure, the average diameter of primary particles in the active material is preferably greater than or equal to 50 nm and less than or equal to 500 nm.

Another embodiment of the present invention is an electrode including a current collector and an active material layer which includes a first aggregate of active materials, a second aggregate of active materials, and a plurality of fibrous carbon-containing compounds. Each of the first aggregate and the second aggregate contains a plurality of primary particles. Each of the plurality of fibrous carbon-containing compounds is a high molecular compound. A monomer of the high molecular compound is at least one selected from the group consisting of thiophene, benzene, pyrrole, aniline, phenol, phthalocyanine, furan, azulene, and a derivative of any of these.

In the above structure, the average diameter of the plurality of fibrous carbon-containing compounds is preferably greater than or equal to 0.01 μm and less than or equal to 50 μm.

In the above structure, the plurality of fibrous carbon-containing compounds preferably have a net-like structure reaching a surface of the active material layer.

In the above structure, the active material layer is preferably provided over the current collector, and the net-like structure is preferably in contact with a surface of the current collector.

In the above structure, the active material is preferably a lithium-containing composite oxide having an olivine crystal structure.

In the above structure, the average diameter of primary particles in the active material is preferably greater than or equal to 50 nm and less than or equal to 500 nm.

Another embodiment of the present invention is a secondary battery including the electrode described in any one of the above structures.

Another embodiment of the present invention is an electronic device including the above-described secondary battery.

### Effect of the Invention

According to one embodiment of the present invention, a conductive additive a small amount of which is used for forming an active material layer with high electron conductivity can be provided. An electrode including a highly filled active material layer having a high density and containing a small amount of a conductive additive can be provided. With use of the electrode, a battery having high capacity per electrode volume can be provided. A novel material, a novel active material particle, a novel battery, a novel secondary battery, a novel power storage device, or a manufacturing method thereof can be provided.

### BRIEF DESCRIPTION OF THE DRAWINGS

FIG. 1A is a perspective view illustrating an electrode. FIG. 1B is a cross-sectional view illustrating an active material layer.

FIG. 2A and FIG. 2B are cross-sectional views of an active material layer.

FIG. 3 illustrates an example of a carbon-containing compound.

FIG. 4A and FIG. 4B are cross-sectional views of an active material layer.

FIG. 5A and FIG. 5B are top views of an active material layer.

FIG. 6A is a cross-sectional view of an active material layer. FIG. 6B and FIG. 6C are diagrams illustrating an example of a manufacturing method of an active material layer of one embodiment of the present invention.

FIG. 7 is a flowchart showing an example of a manufacturing method of an active material layer of one embodiment of the present invention.

FIG. 8A, FIG. 8B, and FIG. 8C are diagrams each illustrating an example of a graphene.

FIG. 9A, FIG. 9B, and FIG. 9C are diagrams illustrating a dispersion state in a polar solvent.

FIG. 10A and FIG. 10B are diagrams illustrating a dispersion state in a polar solvent.

FIG. 11A and FIG. 11B are diagrams illustrating a coin-type secondary battery.

FIG. 12 is a diagram illustrating a laminated secondary battery.

FIG. 13A and FIG. 13B are diagrams illustrating a cylindrical secondary battery.

FIG. 14 is a diagram illustrating electronic devices.

FIG. 15A, FIG. 15B, and FIG. 15C are diagrams illustrating an electronic device.

FIG. 16A and FIG. 16B are diagrams illustrating an electronic device.

FIG. 17 is a diagram illustrating an electronic device.

FIG. 18 is a diagram illustrating an electronic device.

### MODE FOR CARRYING OUT THE INVENTION

Hereinafter, embodiments are described with reference to the drawings. Note that the embodiments can be implemented in many different modes, and it is readily understood by those skilled in the art that modes and details thereof can be changed in various ways without departing from the spirit and scope thereof. Thus, the present invention should not be construed as being limited to the following description of the embodiments.

Note that in each drawing described in this specification, the size, the film thickness, or the region of each component is exaggerated for clarity in some cases. Therefore, embodiments of the present invention are not limited to such scales.

### Embodiment 1

In this embodiment, an electrode for a secondary battery relating to one embodiment of the present invention will be described.

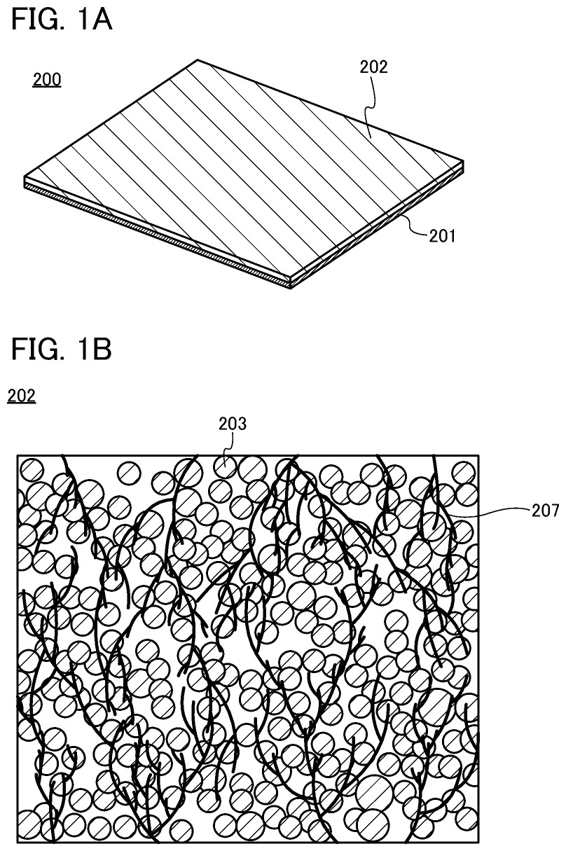

FIG. 1A is a perspective view of an electrode 200. Although the electrode 200 in the shape of a rectangular sheet is illustrated in FIG. 1A, there is no limitation on the shape of the electrode 200 and any shape can be selected as appropriate. The electrode 200 is formed in such a manner that an electrode paste is applied on a current collector 201 and then dried under a reducing atmosphere or reduced pressure to form an active material layer 202. The active material layer 202 is formed on only one surface of the current collector 201 in FIG. 1A but the active material layer 202 may be formed on both surfaces of the current collector 201. The active material layer 202 is not necessarily formed on the entire surface of the current collector 201 and a region that is not coated, such as a region for connection to an electrode tab, is provided as appropriate.

The current collector 201 can be formed using a highly conductive material which is not alloyed with a carrier ion such as lithium, for example, a metal such as stainless steel, gold, platinum, zinc, iron, copper, aluminum, or titanium, or an alloy thereof. Alternatively, it is possible to use an aluminum alloy to which an element that improves heat resistance, such as silicon, titanium, neodymium, scandium, or molybdenum, is added. Still alternatively, the current collector 201 may be formed using a metal element that forms silicide by reacting with silicon. Examples of the metal element that forms silicide by reacting with silicon include zirconium, titanium, hafnium, vanadium, niobium, tantalum, chromium, molybdenum, tungsten, cobalt, and nickel. The current collector 201 can have a foil shape, a plate shape, a sheet shape, a net shape, a punching-metal shape, an expanded-metal shape, or the like as appropriate. The current collector 201 preferably has a thickness greater than or equal to 10 μm and less than or equal to 30 μm.

FIG. 1B is a schematic view illustrating the longitudinal cross-section of the active material layer 202. The active material layer 202 includes particulate active materials 203, a carbon-containing compound 207 as a conductive additive, and a binding agent (also referred to as binder not illustrated).

The active material 203 is a particulate positive electrode active material made of secondary particles having an average particle diameter or particle diameter distribution, which is obtained in such a way that material compounds are mixed at a predetermined ratio and baked and the resulting baked product is crushed, granulated, and classified by an appropriate means. For this reason, although the active material 203 is schematically illustrated as spheres in FIG. 1B or the like, the shape of the active material 203 is not limited to this shape.

For the active material 203, a material into and from which lithium ions can be inserted and extracted can be used.

In the case where carrier ions are alkali metal ions other than lithium ions or alkaline-earth metal ions, for the positive electrode active material, an alkali metal (e.g., sodium or potassium), an alkaline-earth metal (e.g., calcium, strontium, barium, beryllium, or magnesium) may be used instead of lithium in the lithium compounds and the lithium-containing composite oxides.

When the active material 203 is a positive electrode active material, examples of the active material 203 include a lithium-containing composite oxide with an olivine crystal structure, a lithium-containing composite oxide with a layered rock-salt crystal structure, and a lithium-containing composite oxide with a spinel crystal structure.

As the lithium-containing composite oxide with an olivine crystal structure, for example, a composite oxide represented by general formula LiMPO₄ (M is one or more of Fe(II), Mn(II), Co(II), and Ni(II))), and the like can be used. Typical examples of a general formula LiMPO₄ include compounds such as LiFePO₄, LiNiPO₄, LiCoPO₄, LiMnPO₄, LiFeₐNi_{b}PO₄, LiFeₐCo_{b}PO₄, LiFeₐMn_{b}PO₄, LiNiₐCo_{b}PO₄, LiNiₐMn_{b}PO₄ (a+b≤1, 0<a<1, and 0<b<1), LiFe_{c}Ni_{d}CoₑPO₄, LiFe_{c}Ni_{d}MnₑPO₄, LiNi_{c}CO_{d}MnₑPO₄ (c+d+e≤1, 0<c<1, 0<d<1, and 0<e<1), and LiFe_{f}Ni_{g}CoₕMnᵢPO₄ (f+g+h+i≤1, 0<f<1, 0<g<1, 0<h<1, and 0<i<1).

In particular, LiFePO₄ is preferable because it meets requirements with balance for the positive electrode active material, such as safety, stability, high capacity density, high potential, and the existence of lithium ions that can be extracted in initial oxidation (charging).

Meanwhile, the lithium-containing composite oxide with an olivine structure has low electric conductivity in some cases. This sometimes causes a reduction in output characteristics in the secondary battery. An increase in the conductivity of the electrode with a conductive additive enables an increase in output characteristics. Alternatively, for example, a reduction in size of primary particles enables an increase in output characteristics.

With one embodiment of the present invention, an electrode containing a lithium-containing composite oxide with an olivine structure can have excellent output characteristics.

Examples of a lithium-containing composite oxide with a layered rock-salt crystal structure include lithium cobalt oxide (LiCoO₂), LiNiO₂, LiMnO₂, Li₂MnO₃, a NiCo-based material (general formula: LiNiₓCo₁₋ₓO₂ (0<x<1)) such as LiNi_{0.8}Co_{0.2}O₂, a NiMn-based material (general formula: LiNiₓMn₁₋ₓO₂ (0<x<1)) such as LiNi_{0.5}Mn_{0.5}O₂, a NiMnCo-based material (also referred to as NMC; general formula: LiNiₓMn_{y}Co_{1-x-y}O₂ (x>0, y>0, x+y<1)) such as LiNi_{1/3}Mn_{1/3}Co_{1/3}O₂. Moreover, Li(Ni_{0.8}Co_{0.15}Al_{0.05})O₂, Li₂MnO₃—LiMO₂ (M=Co, Ni, or Mn), and the like can be given.

In particular, LiCoO₂ is preferable because it has advantages such as high capacity, higher stability in the air than that of LiNiO₂, and higher thermal stability than that of LiNiO₂.

Examples of the lithium-containing composite oxide with a spinel crystal structure include LiMn₂O₄, Li₁₊ₓMn₂₋ₓO₄, LiMn₂₋ₓAlₓO₄, and LiMn_{1.5}Ni_{0.5}O₄.

It is preferred that a small amount of lithium nickel oxide (LiNiO₂ or LiNi₁₋ₓMₓO₂ (M=Co, Al, or the like)) be mixed into a lithium-containing composite oxide with a spinel crystal structure that contains manganese, such as LiMn₂O₄, in which case advantages such as inhibition of the dissolution of manganese and the decomposition of an electrolytic solution can be obtained. Alternatively, a composite oxide represented by a general formula Li₍₂₋ⱼ₎MSiO₄ (M is one or more of Fe(II), Mn(II), Co(II), and Ni(II); 0≤j≤2) can be used as the positive electrode active material. Typical examples of the general formula Li₍₂₋ⱼ₎MSiO₄ are Li₍₂₋ⱼ₎FeSiO₄, Li₍₂₋ⱼ₎NiSiO₄, Li₍₂₋ⱼ₎CoSiO₄, Li₍₂₋ⱼ₎MnSiO4, Li₍₂₋ⱼ₎FeₖNiₗSiO₄, Li₍₂₋ⱼ₎FeₖCoₗSiO₄, Li₍₂₋₁₎FeₖMnₗSiO₄, Li₍₂₋ⱼ₎NiₖCoₗSiO₄, Li₍₂₋ⱼ₎NiₖMnₗSiO₄ (k+l≤1, 0<k<1, and 0<l<1), Li₍₂₋ⱼ₎FeₘNiₙCo_{q}SiO₄, Li₍₂₋ⱼ₎FeₘNiₙMn_{q}SiO₄, Li₍₂₋ⱼ₎NiₘCoₙMn_{q}SiO₄ (m+n+q≤1, 0<m<1, 0<n<1, and 0<q<1), and Li₍₂₋ⱼ₎FeᵣNiₛCoₜMnᵤSiO₄ (r+s+t+u≤1, 0<r<1, 0<s<1, 0<t<1, and 0<u<1).

Still alternatively, a NASICON compound represented by a general formula AₓM₂(XO₄)₃ (A=Li, Na, or Mg, M=Fe, Mn, Ti, V, Nb, or Al, X=S, P, Mo, W, As, or Si) can be used as the positive electrode active material. Examples of the NASICON compound include Fe₂(MnO₄)₃, Fe₂(SO₄)₃, and Li₃Fe₂(PO₄)₃. Further alternatively, a compound represented by a general formula Li₂MPO₄F, Li₂MP₂O₇, or Li₅MO₄ (M=Fe or Mn), a perovskite fluoride such as FeF₃, a metal chalcogenide (a sulfide, a selenide, or a telluride) such as TiS₂ and MoS₂, a lithium-containing composite oxide with an inverse spinel structure such as LiMVO₄, a vanadium oxide (V₂O₅, V₆O₁₃, LiV₃O₈, and the like), a manganese oxide, or an organic sulfur compound can be used as the positive electrode active material.

When the active material 203 is a negative electrode active material, a material with which lithium can be dissolved and precipitated or a material into and from which lithium ions can be inserted and extracted can be used, and, for example, a lithium metal, a carbon-based material, an alloy-based material, or the like can be utilized.

The lithium metal is preferable for its low redox potential (3.045 V lower than that of a standard hydrogen electrode) and high specific capacity per unit weight and per unit volume (3860 mAh/g and 2062 mAh/cm³).

Examples of the carbon-based material include graphite, graphitizing carbon (soft carbon), non-graphitizing carbon (hard carbon), a carbon nanotube, a graphene, carbon black, and the like.

Examples of the graphite include artificial graphite such as meso-carbon microbeads (MCMB), coke-based artificial graphite, or pitch-based artificial graphite and natural graphite such as spherical natural graphite.

Graphite has a low potential substantially equal to that of a lithium metal (0.1 V to 0.3 V vs. Li/Li⁺) when lithium ions are intercalated into the graphite (while a lithium-graphite intercalation compound is formed). For this reason, a lithium-ion battery can have a high operating voltage. In addition, graphite is preferred because of its advantages such as relatively high capacity per unit volume, small volume expansion, low cost, and safety greater than that of a lithium metal.

For the negative electrode active materials, an alloy-based material which enables charge-discharge reactions by an alloying reaction and a dealloying reaction with lithium metal can be used. For example, in the case where carrier ions are lithium ions, a material including at least one of Al, Si, Ge, Sn, Pb, Sb, Bi, Ag, Zn, Cd, In, Ga, and the like can be used as the alloy-based material. Such elements have higher capacity than carbon, and in particular, silicon has a significantly high theoretical capacity of 4200 mAh/g. For this reason, silicon is preferably used as the negative electrode active material. Examples of an alloy-based material using such elements include Mg₂Si, Mg₂Ge, Mg₂Sn, SnS₂, V₂Sn₃, FeSn₂, CoSn₂, Ni₃Sn₂, Cu₆Sns, Ag₃Sn, Ag₃Sb, Ni₂MnSb, CeSb₃, LaSn₃, La₃Co₂Sn₇, CoSb₃, InSb, and SbSn.

Alternatively, for the negative electrode active material, an oxide such as SiO, SnO, SnO₂, titanium dioxide (TiO₂), lithium titanium oxide (Li₄Ti₅O₁₂), lithium-graphite intercalation compound (LiₓC₆), niobium pentoxide (Nb₂O₅), tungsten oxide (WO₂), or molybdenum oxide (MoO₂) can be used.

Still alternatively, for the negative electrode active material, Li₃₋ₓMₓN (M=Co, Ni, or Cu) with a Li₃N structure, which is a composite nitride of lithium and a transition metal, can be used. For example, Li_{2.6}Co_{0.4}N₃ is preferable because of high charge and discharge capacity (900 mAh/g).

A composite nitride of lithium and a transition metal is preferably used, in which case the negative electrode active material contains lithium ions and thus can be used in combination with a positive electrode active material that does not contain lithium ions, such as V₂O₅ or Cr₃O₈. Note that in the case of using a material containing lithium ions as a positive electrode active material, the composite nitride of lithium and a transition metal can be used for the negative electrode active material by extracting the lithium ions contained in the positive electrode active material in advance.

Alternatively, a material that causes a conversion reaction can be used for the negative electrode active material. For example, a transition metal oxide that does not cause an alloying reaction with lithium, such as cobalt oxide (CoO), nickel oxide (NiO), and iron oxide (FeO), may be used for the negative electrode active material. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃. Note that any of the fluorides can be used as a positive electrode active material because of its high potential.

The carbon-containing compound 207 added to the active material layer 202 as a conductive additive is preferably a fibrous material. Alternatively, the carbon-containing compound 207 is a thread-like material. It is preferable that a plurality of carbon-containing compounds 207 be contacted with each other to form a conductive path. The conductive path formed with the plurality of carbon-containing compounds 207 is for example in contact with the active material 203. It is preferable that the conductive path formed with the plurality of carbon-containing compounds 207 be electrically connected to the active material 203. As the carbon-containing compound 207, a vapor-grown carbon fiber (VGCF (registered trademark)) can be used. Alternatively, the carbon-containing compound 207 may be a fibrous graphene or a curled up graphene like a carbon nanofiber. Alternatively, the carbon-containing compound 207 preferably contains a conductive polymer described below.

It is preferable that the conductive path formed with one or a plurality of carbon-containing compounds 207 be in contact with the surface of the current collector and reach the surface of the active material layer 202. When the conductive path extends from the surface of the current collector to the surface of the active material layer 202, the conductivity of the active material layer 202 in the thickness direction can be increased.

The conductive path formed with one or a plurality of carbon-containing compounds 207 is branched, thereby being able to be dispersed throughout the active material layer 202. Higher dispersibility of the carbon-containing compounds 207 enables high conductivity with a smaller amount of carbon-containing compounds 207. This allows the weight ratio and the volume ratio of the carbon-containing compounds 207 in the active material layer 202 to be reduced; thus, the weight ratio and the volume ratio of the active material 203 in the active material layer 202 can be increased. Consequently, the energy density of the secondary battery can be increased.

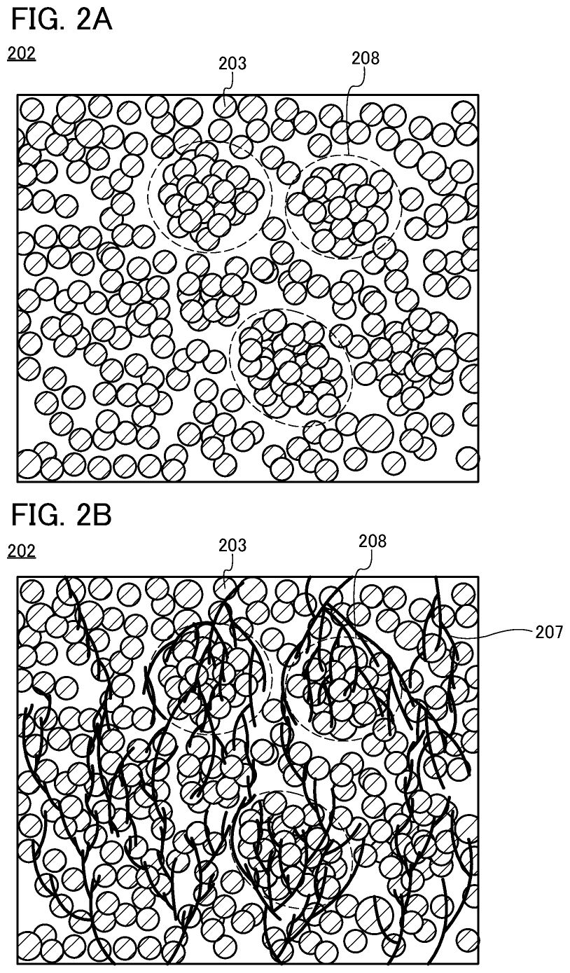

As illustrated in FIG. 2A, a plurality of active materials 203 may form an aggregate 208. In the case where the aggregate 208 is formed with the plurality of active materials 203, for example, the strength of the active material layer 202 is increased in some cases. The strength of the active material layer 202 indicates, for example, the resistance to the peeling test, the inhibition of collapse of the active material from the active material layer 202 after charging/discharging, or the like. Alternatively, in the case where the aggregate 208 is formed with the plurality of active materials 203, for example, the density of the active material layer 202 can be likely to be increased in some cases. An increase in the density of the active material layer 202 enables the energy density of the secondary battery to be increased. The aggregate corresponds to, for example, an aggregated portion formed by a plurality of active materials.

In the case where the plurality of active materials 203 form an aggregate, for example, the plurality of carbon-containing compounds 207 preferably form a conductive path so as to surround the aggregate 208, as illustrated in FIG. 2B. When the carbon-containing compounds 207 surround the aggregate 208, the conductivity of the active material layer 202 is increased in some cases. Furthermore, when the carbon-containing compounds 207 surround the aggregate 208, the density of the active material layer 202 is increased in some cases. Furthermore, when the carbon-containing compounds 207 surround the aggregate 208, the strength of the active material layer 202 is increased in some cases. Moreover, surrounding the aggregate 208 by the carbon-containing compounds 207 acts as relaxing the distortion caused by expansion and contraction of the positive electrode active material occurring at charging/discharging. Consequently, the collapse of the active material layer is inhibited for example, and the cycle characteristics of the secondary battery are improved.

Alternatively, the carbon-containing compound 207 is preferably a fibrous material. When the carbon-containing compound 207 is a fibrous material, the carbon-containing compound 207 may be branched. For example, the carbon-containing compound 207 has a branched resin-based form.

In the case where the carbon-containing compound 207 is a curled up graphene like a carbon nanofiber, for example, three or more carbon nanofibers are connected at a branched portion in such a manner that hexagons formed by carbon of the respective carbon nanofibers are joined. In that case, the hexagon formed by carbon at the branched portion may be distorted.

As the carbon-containing compound included in the active material layer of one embodiment of the present invention, a conductive polymer can be used for example. Examples of a monomer of the conductive polymer include thiophene, benzene, pyrrole, aniline, phenol, phthalocyanine, furan, azulene, and a derivative of any of these. More specifically, 3,4-ethylenedioxythiophene, benzoquinone, or the like can be used. The conductive polymer is for example formed by electrolytic polymerization of monomers as described below. When the monomers are connected and grow through electrolytic polymerization, for example, the tip portion of the growing monomers is branched and grows in some cases. Branching is conceivably generated by connecting a plurality of monomers at the tip portion in growing, for example.

Although there is no particular limitation on the average diameter of the carbon-containing compounds 207, for example, it is preferably smaller than the particle diameter of the active material 203. For example, the average diameter is preferably greater than or equal to 0.01 μm and less than or equal to 1 μm. Furthermore, although there is no particular limitation on the length of the carbon-containing compound 207, for example, it is preferably greater than or equal to 1 μm and less than or equal to 300 μm. In the case where the carbon-containing compound is a resin-based or fibrous material, the diameter of the carbon-containing compound indicates a diameter in a cross section, for example.

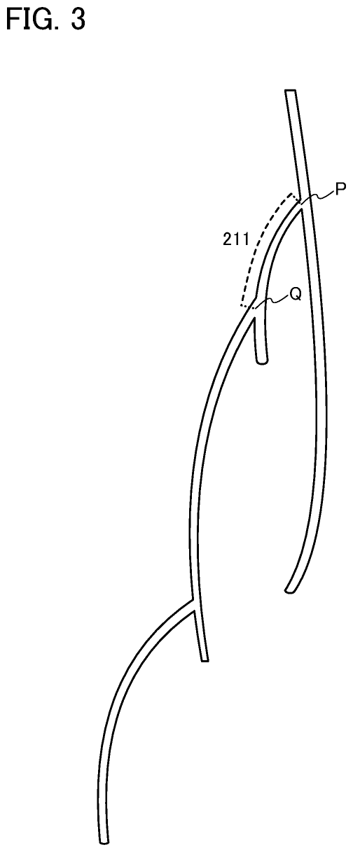

FIG. 3 illustrates an example of a carbon-containing compound with a branched resin-based form. In FIG. 3, for example, a path length 211 from a branched point P to a next branched point Q is greater than or equal to 1 μm and less than or equal to 300 μm.

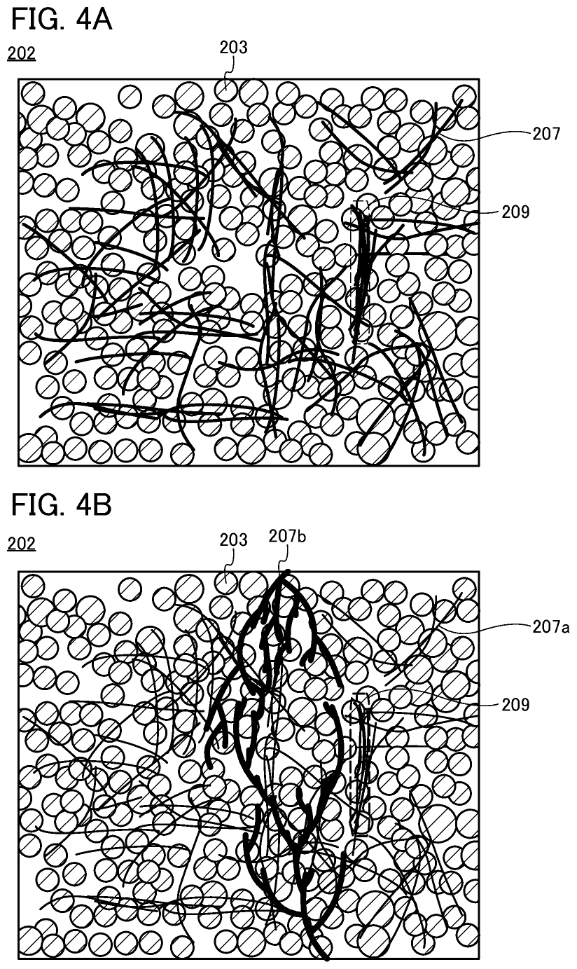

FIG. 4A illustrates an example in which the carbon-containing compounds 207 do not form a conductive path extending from the surface of the current collector to the surface of the active material layer 202 but are arranged collectively at the middle portion or the like in the active material layer 202. Moreover, in FIG. 4, some of the carbon-containing compounds 207 are not dispersed but form an aggregate 209. In the case where a VGCF is used for the carbon-containing compounds 207, for example, the carbon-containing compounds 207 are collectively arranged at the middle portion or the like in the active material layer 202 to form the aggregate 209 in some cases.

FIG. 4B illustrates an example including carbon-containing compounds 207b (indicated by bold lines for clarification) forming a conductive path extending from the surface of the current collector to the surface of the active material layer 202 in addition to the carbon-containing compounds 207 (referred to as carbon-containing compounds 207a in FIG. 4B for clarification) illustrated in FIG. 4A.

The active material layer of one embodiment of the present invention may include one or more materials selected from a graphene, a VGCF, and AB, in addition to a conductive polymer, as the carbon-containing compound.

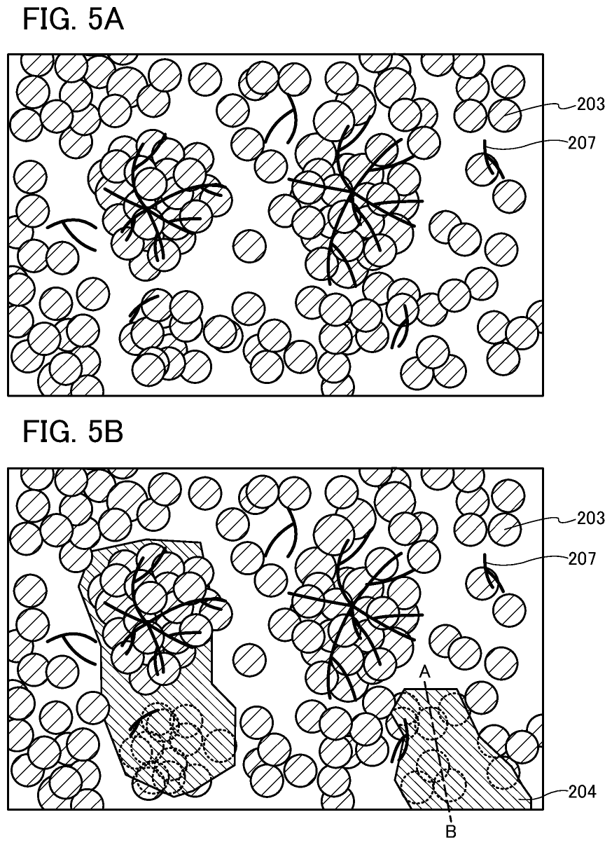

FIG. 5A is a schematic view illustrating a top view of the active material layer 202. In FIG. 5A, the carbon-containing compounds 207 are provided to cover a plurality of active materials 203.

As illustrated in FIG. 5B, the active material layer 202 may include a graphene 204 as the conductive additive in addition to the carbon-containing compound 207. As illustrated in FIG. 5B, a plurality of particulate active materials 203 are coated with a plurality of graphenes 204. The graphene has a shape such as a flat-plate shape or a sheet-like shape. The graphene preferably has a curved shape. One sheet of graphene 204 is electrically connected to the plurality of particulate active materials 203. The plurality of particulate active materials 203 form an aggregate in some cases. The graphene 204 is preferably arranged to surround the aggregate. In addition, one sheet of graphene 204 is electrically connected to the plurality of particulate active materials 203 included in the aggregate.

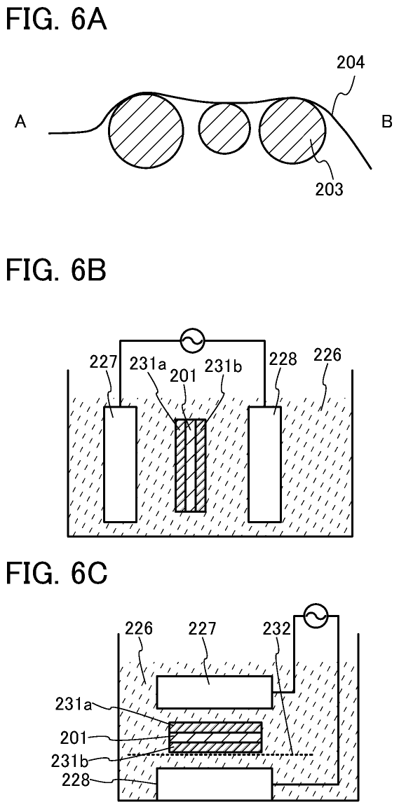

FIG. 6A illustrates an example of a cross section taken along a dashed line A-B in FIG. 5B. The graphene 204 having a curved shape can be in surface contact with the active materials 203 so as to surround part of the surfaces of the active materials 203.

The graphene 204 is capable of surface contact with low contact resistance; accordingly, the electron conductivity of the particulate active materials 203 and the graphene 204 can be improved without an increase in the amount of a conductive additive. Furthermore, surface contact is also made between the plurality of graphenes 204. In addition, the graphene 204 does not necessarily overlap with another graphene only on the surface of the active material layer 202. The graphene 204 is partly provided between a plurality of active material layers 202. The graphene 204 is an extremely thin film (sheet) made of a single layer of carbon molecules or stacked layers thereof and hence are over and in contact with part of the surfaces of the particulate active materials 203 in such a way as to trace these surfaces, and a portion which is not in contact with the active materials 203 is warped between the plurality of particulate active materials 203 and crimped or stretched.

The graphene 204 is formed in such a manner that, for example, a reduction treatment is performed on the graphene oxide whose atomic ratio of oxygen to carbon is greater than or equal to 0.405.

The graphene oxide whose atomic ratio of oxygen to carbon is greater than or equal to 0.405 can be formed by an oxidation method called a Hummers method.

In the Hummers method, a sulfuric acid solution of potassium permanganate, a hydrogen peroxide solution, or the like is mixed into graphite powder to cause an oxidation reaction; thus, a dispersion liquid containing graphite oxide is formed. Through the oxidation of carbon in graphite, functional groups such as an epoxy group, a carbonyl group, a carboxyl group, or a hydroxyl group are bonded in the graphite oxide. Accordingly, the interlayer distance between a plurality of graphenes in the graphite oxide is longer than that in the graphite, so that the graphite oxide can be easily separated into thin pieces by interlayer separation. Then, ultrasonic vibration is applied to the dispersion liquid containing the graphite oxide, so that the graphite oxide whose interlayer distance is long can be cleaved to separate into graphene oxides and to form a dispersion liquid containing graphene oxides. The solvent is removed from the dispersion liquid containing the graphene oxides, so that powdery graphene oxide can be obtained.

Here, the amount of an oxidizer such as potassium permanganate is adjusted as appropriate so that the graphene oxide whose atomic ratio of oxygen to carbon is greater than or equal to 0.405 can be formed. That is, the amount of the oxidizer with respect to the graphite powder is increased, and accordingly the degree of oxidation of the graphene oxide (the atomic ratio of oxygen to carbon) can be increased. The amount of the oxidizer with respect to the graphite powder which is a raw material can be determined depending on the amount of graphene oxides to be formed.

Note that the method for forming a graphene oxide is not limited to the Hummers method using a sulfuric acid solution of potassium permanganate; for example, the Hummers method using nitric acid, potassium chlorate, sodium nitrate, or the like or a method for forming a graphene oxide other than the Hummers method may be employed as appropriate.

Graphite oxide may be separated into thin pieces by application of ultrasonic vibration, by irradiation with microwaves, radio waves, or thermal plasma, or by application of physical stress.

The formed graphene oxide includes an epoxy group, a carbonyl group, a carboxyl group, a hydroxyl group, or the like. In the graphene oxide, oxygen in a functional group is negatively charged in a polar solvent typified by NMP; therefore, while interacting with NMP, the graphene oxide repels with different graphene oxide and they are hardly aggregated. For this reason, in a polar solvent, the graphene oxide can be easily dispersed uniformly.

The length of one side (also referred to as a flake size) of the graphene oxide is greater than or equal to 50 nm and less than or equal to 100 μm, preferably greater than or equal to 800 nm and less than or equal to 20 μm. Particularly in the case where the flake size is smaller than the average particle diameter of the particulate active materials 203, surface contact with the plurality of active materials 203 and connection among the graphenes become difficult, resulting in difficulty in improving the electron conductivity of the active material layer 202.

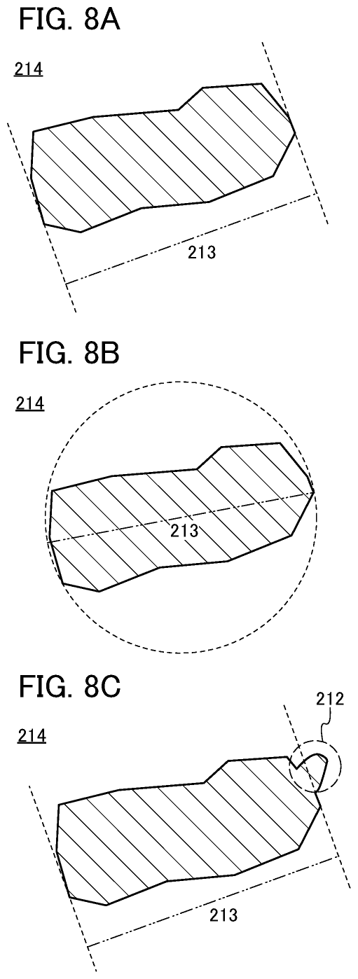

FIG. 8A to FIG. 8C are top views illustrating examples of graphene oxides having various shapes.

FIG. 8A illustrates an example of a length 213 of one side of a graphene oxide 214. As illustrated in FIG. 8B, a minimum circle including the graphene oxide 214 is formed in the top view of the graphene oxide 214, and the diameter of the circle may be the length 213. It is preferable that a protrusion portion 212 not be included in the length 213 of the one side as illustrated in FIG. 8C.

The average particle size of primary particles of the particulate active materials 203 is greater than or equal to 10 nm and less than or equal to 100 μm. A reduction in the average particle size of the primary particles allows the output characteristics of secondary batteries to be increased in some cases. The positive electrode active material of one embodiment of the present invention preferably has an average particle size less than or equal to 500 nm, further preferably greater than or equal to 50 nm and less than or equal to 500 nm.

As the binding agent (binder) included in the active material layer 202, besides polyvinylidene fluoride (PVDF) as a typical one, polyimide, polytetrafluoroethylene, polyvinyl chloride, ethylene-propylene-diene polymer, styrene-butadiene rubber, acrylonitrile-butadiene rubber, fluorine rubber, polyvinyl acetate, polymethyl methacrylate, polyethylene, nitrocellulose or the like can be used.

The above-described active material layer 202 preferably includes the active material 203 at greater than or equal to 85 wt % and less than or equal to 94 wt %, the conductive additive at greater than or equal to 1 wt % and less than or equal to 5 wt %, and the binding agent at greater than or equal to 1 wt % and less than or equal to 5 wt % with respect to the total weight of the active material layer 202. In the case where a conductive polymer and a graphene are both used as the conductive additive, the proportion of the conductive polymer is preferably higher than that of the graphene, for example is preferably 1.5 times of that of the graphene.

The density of the active material layer accounts for, for example, higher than or equal to 30%, further preferably higher than or equal to 50%, still further preferably higher than or equal to 70% of the density of materials used for the active material. In the case where LiFePO₄ is used for the active material in the active material layer of one embodiment of the present invention, the density of the active material layer is preferably 1.1 g/cm³, further preferably higher than or equal to 1.8 g/cm³, still further preferably higher than or equal to 2.6 g/cm³.

### Example 1 of Formation Method

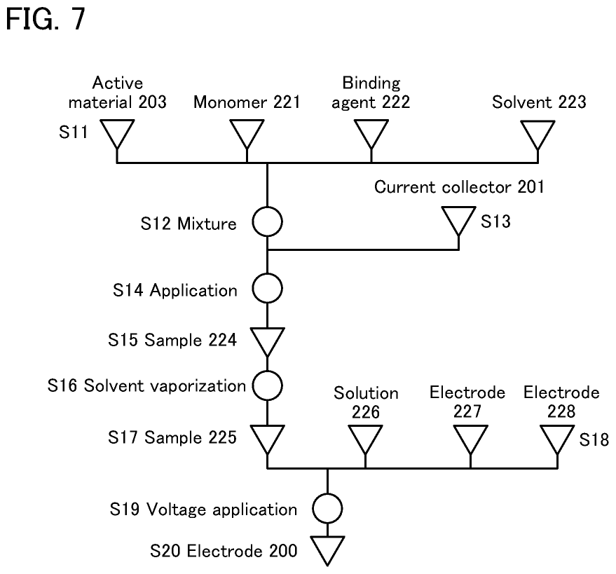

An example of a method for forming the active material layer of one embodiment of the present invention is shown in a flow chart of FIG. 7.

The active material 203, a monomer 221 of a carbon-containing compound, a binding agent 222, and a solvent 223 are prepared in Step S11 and mixed to form a slurry in Step S12.

As the solvent, for example, one or more solvents selected from a non-polar solvent, a protic polar solvent, an aprotic polar solvent, and the like can be used by mixing. More specifically, as the solvent, water, NMP (also referred to as N-methylpyrrolidone, 1-methyl-2-pyrrolidone, or N-methyl-2-pyrrolidone), or the like an be used. The solvent preferably has low solubility with respect to a monomer of a carbon-containing compound.

Next, the current collector 201 is prepared in Step S13, the formed slurry is applied to one surface of the current collector 201 in Step S14, and a sample 224 including a first layer is formed on the one surface of the current collector 201 in Step S15.

Next, the solvent included in the first layer is vaporized by heating in Step S16, and a sample 225 including a layer 231a is formed on the one surface of the current collector 201 in Step S17. The heating may be performed in a reduced pressure.

Furthermore, the slurry may be applied to the other surface of the current collector 201, and the solvent is vaporized, whereby a layer 231b may be formed on the other surface of the current collector 201.

Next, a solution 226, an electrode 227, and an electrode 228 are prepared in Step S18.

The solution 226 contains a supporting electrolyte and a solvent. In addition, a monomer may be dispersed in the solution 226.

As the supporting electrolyte in the solution 226, a known supporting electrolyte can be used. The supporting electrolyte contains, for example, as a cation, an alkali metal ion, an alkaline earth metal ion, a transition metal ion, a pyridinium ion, an imidazolium ion, a quaternary phosphonium ion, and the like. In addition, the supporting electrolyte contains, for example, as an anion, halogen, a PF₆ ion, a ClO₄ ion, an AsF₆ ion, a BF₄ ion, an AlCl₄ ion, an SCN ion, an SO₄ ion, a B₁₀Cl₁₀ ion, a B₁₂Cl₁₂ ion, a CF₃SO₃ ion, a C₄F₉SO₃ ion, a C(CF₃SO₂)₃ ion, a C(C₂F₅SO₂)₃ ion, a N(CF₃SO₂)₂ ion, a N(C₄F₉SO₂)(CF₃SO₂) ion, a N(C₂F₅SO₂)₂ ion, and the like.

As the solvent in the solution 226, for example, one of water, acetonitrile, nitrobenzene, hexane, toluene, diethyl ether, benzene, ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination in an appropriate ratio.

Each of the electrode 227 and the electrode 228 preferably has a flat plate-like shape.

Next, the sample 225 is immersed into the solution 226. As shown in an example of FIG. 6B, the electrode 227 and the electrode 228 are preferably arranged to be substantially parallel to each other in the solution 226. Furthermore, the current collector 201 included in the sample 225 is preferably arranged to be substantially parallel to the electrode 227 and the electrode 228. As illustrated in FIG. 6C, the electrode 200 may be provided over an insulating mech 232.

Next, a voltage is applied between the electrode 227 and the electrode 228 in Step S19. The applied voltage is a DC voltage. Alternatively, an AC voltage is applied, for example. The voltage level and the AC frequency in voltage application may be adjusted as appropriate. The voltage application induces electrolytic polymerization in the monomers of the carbon-containing compound in the layer 231a and the layer 231b, so that a polymer is formed. The polymer is preferably formed so that its fibers are aligned along the direction substantially perpendicular to the surface of the current collector 201. It is preferable that the polymer form a conductive path linking the current collector 201 and the metal layer.

The case where the AC voltage is applied to the electrode 227 and the electrode 228 is described. When either positive or negative polarity (here, negative voltage for example) is applied to the electrode 227, for example, the monomers included in the layer 231a are polymerized through electrolysis to form a polymer. When either positive or negative polarity (here, negative voltage for example) is applied to the electrode 228, for example, the monomers included in the layer 231b are polymerized through electrolysis.

In the case where a plurality of active materials 203 form the aggregate 208 at this point, the polymer might grow to pass between the aggregate 208 and the active material 203 or between a plurality of aggregates 208 as shown in an example of FIG. 2B. In such a case, growth of the polymer might be promoted. In addition, the polymer might grow to surround the aggregate 208.

In Step S20 after the above-described steps, the electrode 200 in which the active material layer 202 containing the conductive polymer is formed on both surfaces of the current collector 201 can be obtained.

In Step S12 in the above-described formation method, a graphene oxide may be added as a material to be a conductive additive, in addition to the monomer of the carbon-containing compound. The graphene oxide has functional groups, and thus has high dispersibility in the slurry.

The graphene oxide can be reduced by a heating step. The graphene oxide may be reduced by heating in Step S16, for example. Alternatively, the voltage is applied to cause a reduction reaction so that the graphene oxide can be reduced. For example, in Step S15, the reduction may be caused by voltage application. Alternatively, the graphene oxide can be reduced when being immersed into a solution containing a reducing agent. For example, in Step S15, ascorbic acid, hydrazine, dimethyl hydrazine, hydroquinone, sodium boronhydride (NaBH₄), LiAlH₄, N,N-diethylhydroxylamine, or the like is added to a solution 1, so that the graphene oxide may be reduced.

This embodiment can be implemented in appropriate combination with the other embodiments.

### Embodiment 2

In this embodiment, a graphene in the electrode of the secondary battery of one embodiment of the present invention will be described.

A graphene is a carbon material having a crystal structure in which hexagonal skeletons of carbon are spread in a planar form. The graphene is one atomic plane extracted from graphite crystals. Due to its electrical, mechanical, or chemical characteristics which are surprisingly excellent, the graphene has been expected to be applied to a variety of fields of, for example, field-effect transistors with high mobility, highly sensitive sensors, highly-efficient solar cells, and next-generation transparent conductive films and has attracted a great deal of attention.

In this specification, a graphene includes a single-layer graphene or a multilayer graphene including two to hundred layers in its category. A single-layer graphene refers to a one-atomic-layer thick sheet of carbon molecules having π bonds. Graphene oxide refers to a compound formed by oxidation of such a graphene. When graphene oxide is reduced to form a graphene, oxygen contained in the graphene oxide is not entirely released and part of the oxygen remains in the graphene. When the graphene contains oxygen, the ratio of the oxygen to the entire graphene measured by XPS is higher than or equal to 2 atomic % and lower than or equal to 20 atomic %, preferably higher than or equal to 3 atomic % and lower than or equal to 15 atomic %.

In the case where the graphene is multilayer graphene including graphene obtained by reducing graphene oxide, the interlayer distance of the graphene is greater than or equal to 0.34 nm and less than or equal to 0.5 nm, preferably greater than or equal to 0.38 nm and less than or equal to 0.42 nm, further preferably greater than or equal to 0.39 nm and less than or equal to 0.41 nm. In general graphite, the interlayer distance of single-layer graphene is 0.34 nm. Since the interlayer distance in the graphene used for the secondary battery of one embodiment of the present invention is longer than that in the general graphite, carrier ions can easily transfer between layers of the graphene in the multilayer graphene.

In the electrode for a secondary battery of one embodiment of the present invention, the graphene is dispersed so as to overlap with each other in an active material layer and be in contact with a plurality of active material particles. In other words, an electron conductive network is formed by the graphene in an active material layer. This maintains bonds between the plurality of active material particles, which enables an active material layer with high electron conductivity to be formed.

An active material layer to which a graphene is added as a conductive additive can be formed by the following method. First, after the graphene is dispersed into a dispersion medium (also referred to as a solvent), an active material is added thereto and a mixture is obtained by mixing. A binding agent (also referred to as a binder) is added to this mixture and mixing is performed, so that an electrode paste is formed. Lastly, after the electrode paste is applied to a current collector, the dispersion medium is volatilized. Thus, the active material layer including a graphene as a conductive additive is formed.

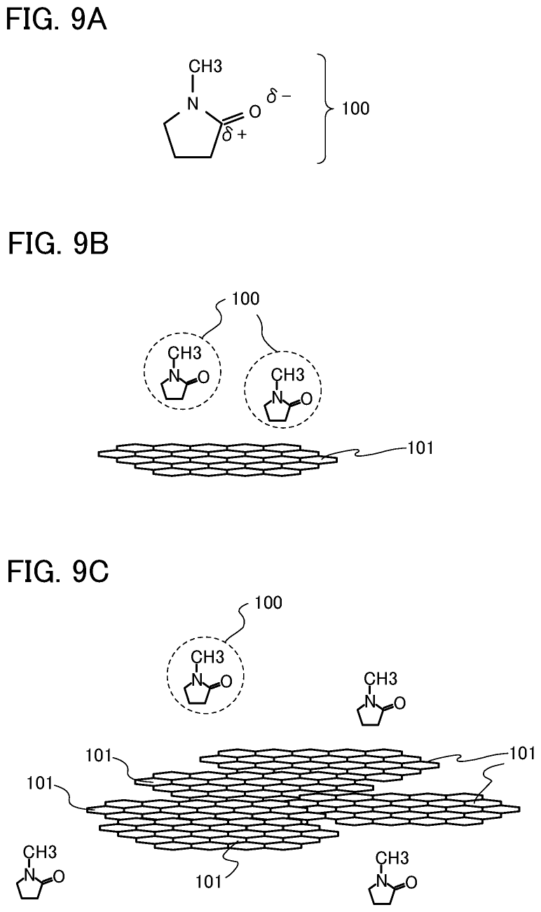

A graphene oxide is more likely to have a functional group than a graphene and thus can have higher dispersibility in slurry. FIG. 9A shows a typical structural formula of NMP as a dispersion medium. NMP 100 is a compound having a five-membered ring structure and is one of polar solvents. As illustrated in FIG. 9A, in the NMP, oxygen is electrically negatively (−) biased and carbon forming a double bond with the oxygen is electrically positively (+) biased. Graphene, RGO, or graphene oxide is added to a diluent solvent having such a polarity.

The graphene is a crystal structure body of carbon in which hexagonal skeletons are spread in a planar form as already described, and does not substantially include a functional group in the structure body. Furthermore, the RGO is formed by reduction of functional groups originally included therein by heat treatment, and the ratio of functional groups in the structure body is as low as about 10 wt %. Consequently, as illustrated in FIG. 9B, a surface of a graphene or RGO 101 does not have polarity and therefore has hydrophobicity. Therefore it is considered that, while interaction between the NMP 100 which is a dispersion medium and the graphene or RGO 101 is extremely weak, interaction occurs between the graphene or the RGO 101 to cause aggregation of the graphenes or RGO 101 (see FIG. 9C).

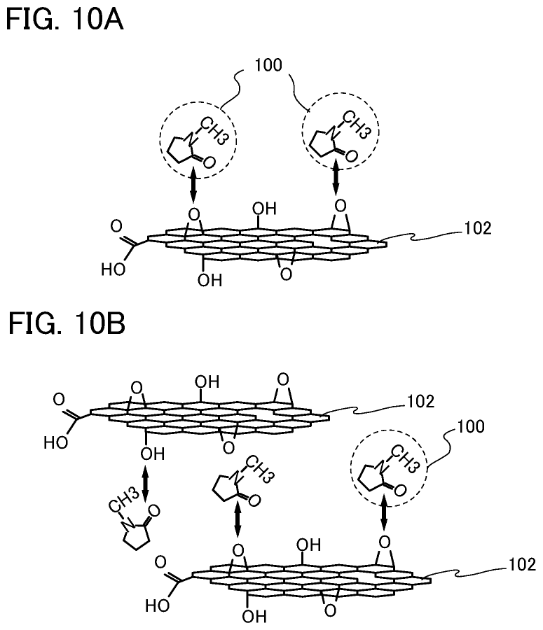

A graphene oxide 102 is a polar substance having a functional group such as an epoxy group, a carbonyl group, a carboxyl group, or a hydroxyl group. Oxygen in the functional group in the graphene oxide 102 is negatively charged; hence, in a polar solvent, different graphene oxides hardly aggregate but strongly interact with the NMP 100 which is a polar solvent (see FIG. 10A). Thus, as illustrated in FIG. 10B, the functional group such as an epoxy group included in the graphene oxide 102 interacts with the polar solvent, which inhibits aggregation of graphene oxides; consequently, the graphene oxide 102 is considered to be uniformly dispersed in a dispersion medium (see FIG. 10B).

In view of the foregoing, in order that a network with high electron conductivity be formed in an active material layer by using the graphene as a conductive additive, use of the graphene oxide with high dispersibility in a dispersion medium in manufacture of an electrode paste is very effective. The dispersion property of graphene oxide in a dispersion medium probably depends on the quantity of functional groups having oxygen such as an epoxy group (in other words, the degree of oxidation of graphene oxide).

Therefore, one embodiment of the present invention is a graphene oxide used as a raw material of a conductive additive used in an electrode for secondary battery, and is a graphene oxide in which the atomic ratio of oxygen to carbon is greater than or equal to 0.405.

Here, the atomic ratio of oxygen to carbon is an indicator of the degree of oxidation and represents the weight of oxygen which is a constituent element of the graphene oxide as a proportion with respect to the weight of carbon which is a constituent element of the graphene oxide. Note that the weights of elements included in graphene oxide can be measured by X-ray photoelectron spectroscopy (XPS), for example.

The atomic ratio of oxygen to carbon in the graphene oxide which is greater than or equal to 0.405 means that the graphene oxide is a polar substance in which functional groups such as an epoxy group, a carbonyl group, a carboxyl group, or a hydroxyl group are sufficiently bonded to the graphene oxide for the high dispersibility of the graphene oxide in a polar solvent.

The graphene oxide in which the atomic ratio of oxygen to carbon is greater than or equal to 0.405 is dispersed into a dispersion medium together with an active material and a binder, mixed, and applied on a current collector, and heating is performed. Thus, an electrode for a secondary battery which includes graphene with a high dispersion property and an electron conductive network can be formed.

The length of one side of the graphene oxide is preferably greater than or equal to 50 nm and less than or equal to 100 μm, further preferably greater than or equal to 800 nm and less than or equal to 20 μm.

Another embodiment of the present invention is an electrode for a secondary battery which includes an active material layer including a plurality of particulate active materials, a conductive additive including a plurality of graphenes, and a binding agent over a current collector. The graphene in each sheet is larger than an average particle diameter of each of the particulate active materials. The graphene is dispersed in the active material layer such that the graphene make surface contact with one or more adjacent graphenes. The graphene make surface contact in such a way as to wrap part of a surface of the particulate active material.

Another embodiment of the present invention is an electrode for a secondary battery which includes an active material layer including a plurality of particulate active materials, a conductive additive including a plurality of graphenes, and a binding agent over a current collector. As bonding states of carbon included in the active material layer, the proportion of a C═C bond is greater than or equal to 35% and the proportion of a C—O bond is greater than or equal to 5% and less than or equal to 20%.

Another embodiment of the present invention is a method for manufacturing an electrode for a secondary battery, in which a graphene oxide in which the atomic ratio of oxygen to carbon is greater than or equal to 0.405 is dispersed into a dispersion medium; an active material is added to the dispersion medium into which the graphene oxide is dispersed and mixing is performed to form a mixture; a binding agent is added to the mixture and mixing is performed to form an electrode paste; the electrode paste is applied on a current collector; and the graphene oxide is reduced after or at the same time when the dispersion medium included in the applied positive electrode paste is volatilized, whereby an active material layer including the graphene is formed over the current collector.

When the graphene contains oxygen, the ratio of the oxygen to the entire graphene measured by XPS is higher than or equal to 2 atomic % and lower than or equal to 20 atomic %, preferably higher than or equal to 3 atomic % and lower than or equal to 15 atomic %. As the ratio of oxygen is lower, the conductivity of the graphene can be higher, so that a network with high electron conductivity can be formed. As the ratio of oxygen becomes higher, more gaps serving as paths of ions can be formed in the graphene.

This embodiment can be implemented in appropriate combination with the other embodiments.

### Embodiment 3

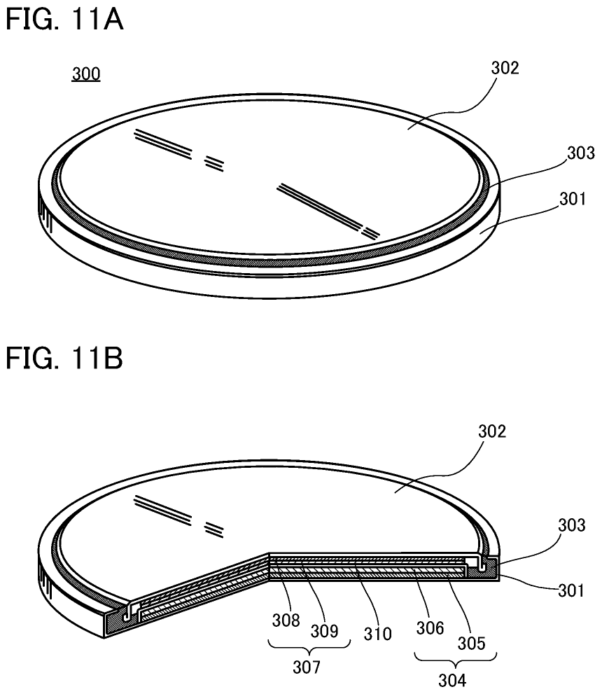

In this embodiment, a structure of a secondary battery will be described with reference to FIG. 11.

FIG. 11A is an external view of a coin-type (single-layer flat type) secondary battery, and FIG. 11B is a cross-sectional view thereof.

In a coin-type secondary battery 300, a positive electrode can 301 doubling as a positive electrode terminal and a negative electrode can 302 doubling as a negative electrode terminal are insulated from each other and sealed by a gasket 303 made of polypropylene or the like. A positive electrode 304 includes a positive electrode current collector 305 and a positive electrode active material layer 306 provided in contact with the positive electrode current collector 305. A negative electrode 307 includes a negative electrode current collector 308 and a negative electrode active material layer 309 provided in contact with the negative electrode current collector 308. Between the positive electrode active material layer 306 and the negative electrode active material layer 309 is a separator 310 and an electrolyte (not illustrated).

For at least one of the positive electrode 304 and the negative electrode 307, the electrode 200 described in Embodiment 1 can be used.

As the separator 310, an insulator such as cellulose (paper), or polyethylene or polypropylene with pores can be used.

For the electrolyte in an electrolyte solution, a material containing carrier ions is used. Typical examples of the electrolyte include lithium salts such as LiClO₄, LiAsF₆, LiBF₄, LiPF₆, and Li(C₂F₅SO₂)₂N. The electrolyte including an anion that is any one of anions as described above for the supporting electrolyte in the solution 226 can be used.

Note that in the case where the carrier ions are alkali metal ions other than lithium ions or alkaline-earth metal ions, an alkali metal (e.g., sodium or potassium), an alkaline-earth metal (e.g., calcium, strontium, barium, beryllium, or magnesium), or the like may be used, instead of lithium, for the electrolyte in the above lithium salts.

Furthermore, as a solvent of the electrolyte solution, a material that can transfer carrier ions is used. As the solvent of the electrolyte solution, an aprotic organic solvent is preferably used. Typical examples of aprotic organic solvents include ethylene carbonate (EC), propylene carbonate, dimethyl carbonate, diethyl carbonate (DEC), γ-butyrolactone, acetonitrile, dimethoxyethane, tetrahydrofuran, and the like, and one or more of these can be used. When a gelled high-molecular material is used as the solvent of the electrolyte solution, safety against liquid leakage and the like is improved. Furthermore, a secondary battery can be thinner and more lightweight. Typical examples of gelled high-molecular materials include a silicone gel, an acrylic gel, an acrylonitrile gel, a polyethylene oxide-based gel, a polypropylene oxide-based gel, and a gel of a fluorine-based polymer. Alternatively, the use of one or more of ionic liquids (room temperature molten salts) which are less likely to burn and volatilize as the solvent of the electrolyte solution can prevent the secondary battery from exploding or catching fire even when the secondary battery internally shorts out or the internal temperature increases due to overcharge or the like.

Instead of the electrolyte solution, a solid electrolyte including an inorganic material such as a sulfide-based inorganic material or an oxide-based inorganic material, or a solid electrolyte including a high-molecular material such as a PEO (polyethylene oxide)-based high-molecular material may alternatively be used. When the solid electrolyte is used, a separator and a spacer are not necessary. Furthermore, the battery can be entirely solidified; therefore, there is no possibility of liquid leakage and thus the safety of the battery is dramatically increased.

For the positive electrode can 301 and the negative electrode can 302, a metal having a corrosion-resistant property to a liquid such as an electrolytic solution in charging and discharging a secondary battery, such as nickel, aluminum, or titanium; an alloy of any of the metals; an alloy containing any of the metals and another metal (e.g., stainless steel); a stack of any of the metals; a stack including any of the metals and any of the alloys (e.g., a stack of stainless steel and aluminum); or a stack including any of the metals and another metal (e.g., a stack of nickel, iron, and nickel) can be used. The positive electrode can 301 and the negative electrode can 302 are electrically connected to the positive electrode 304 and the negative electrode 307, respectively.

The negative electrode 307, the positive electrode 304, and the separator 310 are immersed in the electrolyte solution. Then, as illustrated in FIG. 11B, the positive electrode 304, the separator 310, the negative electrode 307, and the negative electrode can 302 are stacked in this order with the positive electrode can 301 positioned at the bottom, and the positive electrode can 301 and the negative electrode can 302 are subjected to pressure bonding with the gasket 303 located therebetween. In such a manner, the coin-type secondary battery 300 can be formed.

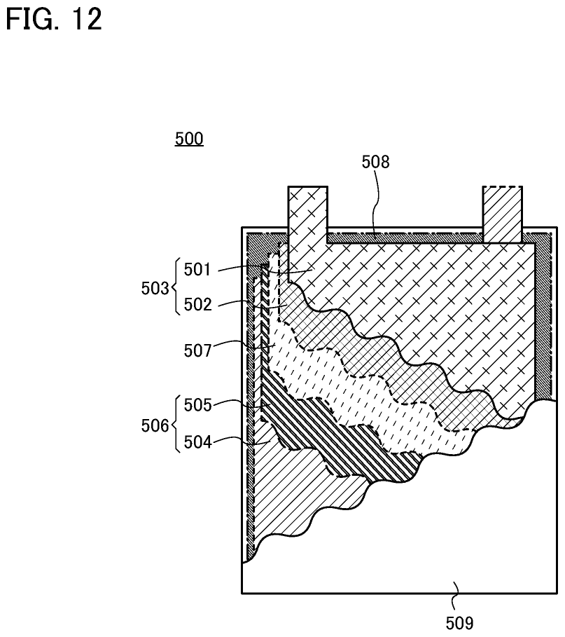

Next, an example of a laminated secondary battery will be described with reference to FIG. 12.

A laminated secondary battery 500 illustrated in FIG. 12 includes a positive electrode 503 including a positive electrode current collector 501 and a positive electrode active material layer 502, a negative electrode 506 including a negative electrode current collector 504 and a negative electrode active material layer 505, a separator 507, an electrolyte solution 508, and an exterior body 509. The separator 507 is provided between the positive electrode 503 and the negative electrode 506 in the exterior body 509. The exterior body 509 is filled with the electrolyte solution 508.

In the laminated secondary battery 500 illustrated in FIG. 12, the positive electrode current collector 501 and the negative electrode current collector 504 also serve as terminals for electrical contact with the outside. For this reason, parts of the positive electrode current collector 501 and the negative electrode current collector 504 are arranged to be exposed from the exterior body 509 to the outside.

As the exterior body 509 of the laminated secondary battery 500, for example, a laminate film having a three-layer structure can be employed in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body. With such a three-layer structure, the passage of an electrolytic solution and a gas can be blocked and an insulating property and resistance to the electrolytic solution can be provided.

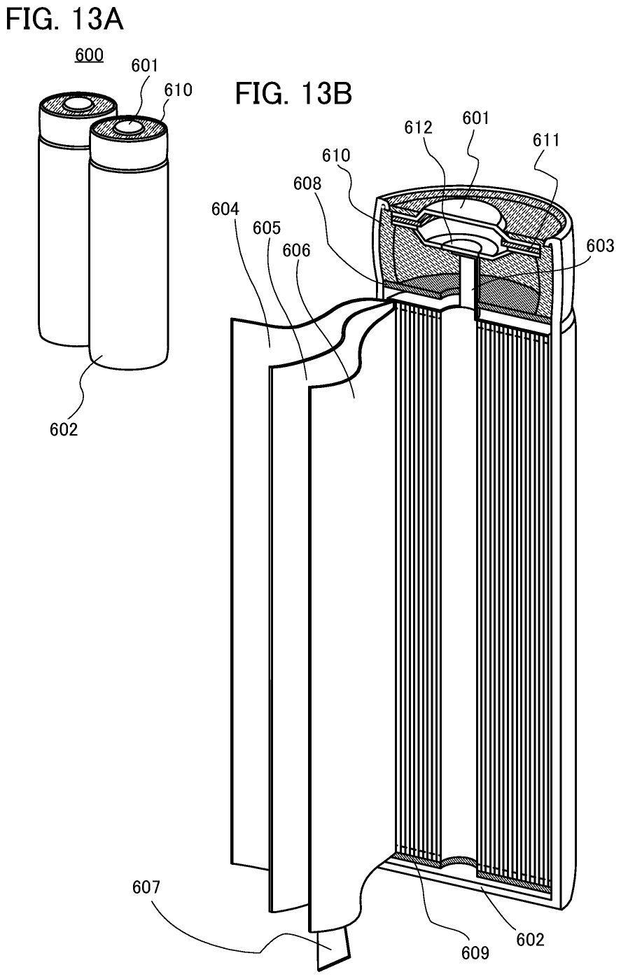

Next, an example of a cylindrical secondary battery is described with reference to FIG. 13. A cylindrical secondary battery 600 includes, as illustrated in FIG. 13A, a positive electrode cap (battery lid) 601 on the top surface and a battery can (outer can) 602 on the side and bottom surfaces. The positive electrode cap and the battery can (outer can) 602 are insulated from each other by a gasket (insulating gasket) 610.

FIG. 13B is a schematic cross-sectional view of a cylindrical secondary battery. Inside the battery can 602 having a hollow cylindrical shape, a battery element in which a strip-like positive electrode 604 and a strip-like negative electrode 606 are wound with a separator 605 located therebetween is provided. Although not illustrated, the battery element is wound around a center pin. One end of the battery can 602 is closed and the other end thereof is opened. For the battery can 602, a metal having a corrosion-resistant property to a liquid such as an electrolytic solution in charging and discharging a secondary battery, such as nickel, aluminum, or titanium; an alloy of any of the metals; an alloy containing any of the metals and another metal (e.g., stainless steel); a stack of any of the metals; a stack including any of the metals and any of the alloys (e.g., a stack of stainless steel and aluminum); or a stack including any of the metals and another metal (e.g., a stack of nickel, iron, and nickel) can be used. Inside the battery can 602, the battery element in which the positive electrode, the negative electrode, and the separator are wound is sandwiched between a pair of insulating plates 608 and 609 that face each other. Furthermore, a nonaqueous electrolyte solution (not illustrated) is injected inside the battery can 602 provided with the battery element. A non-aqueous electrolyte solution which is similar to that of the coin-type secondary or the laminated secondary battery can be used.

Although the positive electrode 604 and the negative electrode 606 can be formed in a manner similar to that of the positive electrode and the negative electrode of the above-described coin-type secondary battery, the difference lies in that, since the positive electrode and the negative electrode of the cylindrical secondary battery are wound, active materials are formed on both sides of the current collectors. A positive electrode terminal (positive electrode current collecting lead) 603 is connected to the positive electrode 604, and a negative electrode terminal (negative electrode current collecting lead) 607 is connected to the negative electrode 606. For both the positive electrode terminal 603 and the negative electrode terminal 607, a metal material such as aluminum can be used. The positive electrode terminal 603 and the negative electrode terminal 607 are resistance-welded to a safety valve mechanism 612 and the bottom of the battery can 602, respectively. The safety valve mechanism 612 is electrically connected to the positive electrode cap 601 through a positive temperature coefficient (PTC) element 611. The safety valve mechanism 612 cuts off electrical connection between the positive electrode cap 601 and the positive electrode 604 when the internal pressure of the battery exceeds a predetermined threshold value. In addition, the PTC element 611 is a thermally sensitive resistor whose resistance increases as temperature rises, and limits the amount of current by increasing the resistance to prevent abnormal heat generation. Barium titanate (BaTiO₃)-based semiconductor ceramics or the like can be used for the PTC element.

Note that in this embodiment, the coin-type secondary battery, the laminated secondary battery, and the cylindrical secondary battery are given as the secondary batteries; however, any of secondary batteries with the other various shapes, such as a sealing-type secondary battery and a square-type secondary battery, can be used. Furthermore, a structure in which a plurality of positive electrodes, negative electrodes, and separators are stacked or a structure in which a positive electrode, a negative electrode, and a separator are rolled may be employed.

A positive electrode of one embodiment of the present invention is used as each of the positive electrodes of the secondary battery 300, the secondary battery 500, and the secondary battery 600 described in this embodiment. Thus, the discharge capacity of each of the secondary battery 300, the secondary battery 500, and the secondary battery 600 can be increased.

This embodiment can be implemented in appropriate combination with the other embodiments.

### Embodiment 4

A secondary battery of one embodiment of the present invention can be used for power supplies of a variety of electrical appliances driven by electric power.

Specific examples of electrical appliances each utilizing the secondary battery of one embodiment of the present invention are display devices of televisions, monitors, and the like, lighting devices, desktop personal computers and laptop personal computers, word processors, image reproduction devices which reproduce still images or moving images stored in recording media such as DVDs (Digital Versatile Discs), portable CD players, radios, tape recorders, headphone stereos, stereos, table clocks, wall clocks, cordless phone handsets, transceivers, cellular phones, car phones, portable game machines, calculators, portable information terminals, electronic notebooks, e-book readers, electronic translators, audio input devices, video cameras, digital still cameras, toys, electric shavers, high-frequency heating appliances such as microwave ovens, electric rice cookers, electric washing machines, electric vacuum cleaners, water heaters, electric fans, hair dryers, air-conditioning systems such as air conditioners, humidifiers, and dehumidifiers, dishwashers, dish dryers, clothes dryers, futon dryers, electric refrigerators, electric freezers, electric refrigerator-freezers, freezers for preserving DNA, flashlights, electric power tools such as chain saws, smoke detectors, and medical equipment such as dialyzers. Other examples include industrial equipment such as guide lights, traffic lights, conveyor belts, elevators, escalators, industrial robots, power storage systems, and power storage devices for leveling the amount of power supply and smart grid. In addition, moving objects driven by electric motors using power from the secondary batteries are also included in the category of electrical appliances. Examples of the moving objects include electric vehicles (EVs), hybrid electric vehicles (HVs) that include both an internal-combustion engine and a motor, plug-in hybrid electric vehicles (PHVs), tracked vehicles in which caterpillar tracks are substituted for wheels of these vehicles, motorized bicycles including motor-assisted bicycles, motorcycles, electric wheelchairs, golf carts, boats or ships, submarines, helicopters, aircraft, rockets, artificial satellites, space probes, planetary probes, and spacecraft.

In the above electrical appliances, the secondary battery of one embodiment of the present invention can be used as a main power supply for supplying power for almost the whole power consumption. Alternatively, in the above electrical appliances, the secondary battery of one embodiment of the present invention can be used as an uninterruptible power supply which can supply power to the electrical appliances when the supply of power from the above main power supply or a commercial power supply is stopped. Still alternatively, in the above electrical appliances, the secondary battery of one embodiment of the present invention can be used as an auxiliary power supply for supplying power to the electrical appliances at the same time as the power supply from the above main power supply or a commercial power supply.

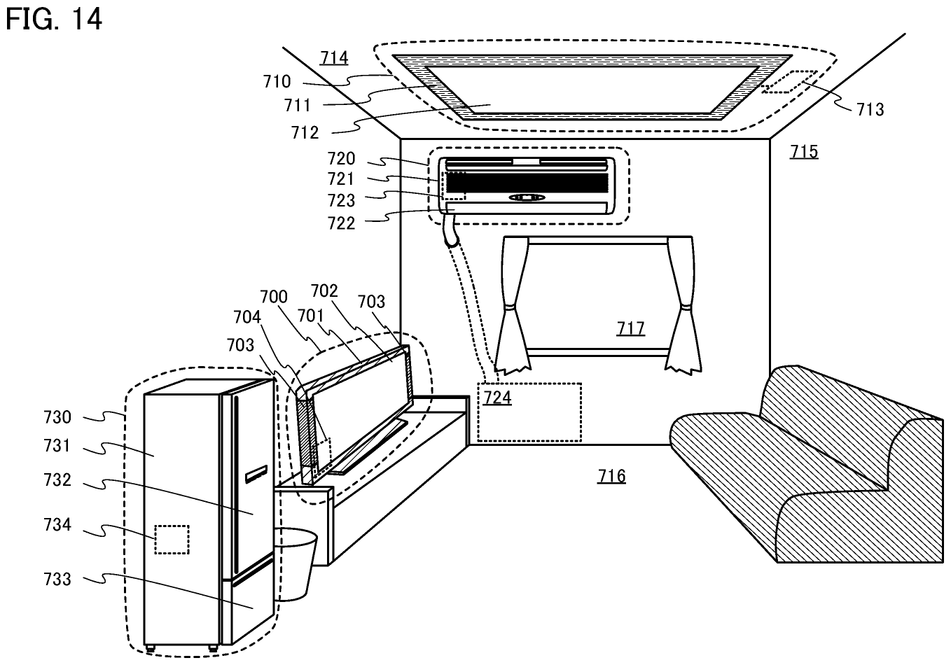

FIG. 14 illustrates specific structures of the electric appliances. In FIG. 14, a display device 700 is an example of an electrical appliance including a secondary battery 704 of one embodiment of the present invention. Specifically, the display device 700 corresponds to a display device for TV broadcast reception and includes a housing 701, a display portion 702, speaker portions 703, the secondary battery 704, and the like. The secondary battery 704 of one embodiment of the present invention is provided in the housing 701. The display device 700 can receive power from a commercial power supply and can use power stored in the secondary battery 704. Thus, the display device 700 can be utilized with use of the secondary battery 704 of one embodiment of the present invention as an uninterruptible power supply even when power cannot be supplied from a commercial power supply due to power failure or the like.

For the display portion 702, a semiconductor display device such as a liquid crystal display device, a light-emitting device in which a light-emitting element such as an organic EL element is provided in each pixel, an electrophoresis display device, a DMD (Digital Micromirror Device), a PDP (Plasma Display Panel), or an FED (Field Emission Display) can be used.

Note that the display device includes, in its category, all of information display devices for personal computers, advertisement display, and the like besides for TV broadcast reception.

In FIG. 14, an installation lighting device 710 is an example of an electrical appliance including a secondary battery 713 of one embodiment of the present invention. Specifically, the lighting device 710 includes a housing 711, a light source 712, the secondary battery 713, and the like. Although FIG. 14 illustrates the case where the secondary battery 713 is provided in a ceiling 714 on which the housing 711 and the light source 712 are installed, the secondary battery 713 may be provided in the housing 711. The lighting device 710 can receive power from a commercial power supply and can use power stored in the secondary battery 713. Thus, the lighting device 710 can be utilized with use of the secondary battery 713 of one embodiment of the present invention as an uninterruptible power supply even when power cannot be supplied from a commercial power supply due to power failure or the like.

Note that although the installation lighting device 710 provided in the ceiling 714 is illustrated in FIG. 14 as an example, the secondary battery of one embodiment of the present invention can be used for an installation lighting device provided in, for example, a sidewall 715, a floor 716, a window 717, or the like other than the ceiling 714, or can be used in a tabletop lighting device or the like.

As the light source 712, an artificial light source which emits light artificially by using power can be used. Specific examples of the artificial light source include an incandescent lamp, a discharge lamp such as a fluorescent lamp, and light-emitting elements such as an LED and an organic EL element.

In FIG. 14, an air conditioner including an indoor unit 720 and an outdoor unit 724 is an example of an electrical appliance including a secondary battery 723 of one embodiment of the present invention. Specifically, the indoor unit 720 includes a housing 721, an air outlet 722, the secondary battery 723, and the like. Although FIG. 14 illustrates the case where the secondary battery 723 is provided in the indoor unit 720, the secondary battery 723 may be provided in the outdoor unit 724. Alternatively, the secondary batteries 723 may be provided in both the indoor unit 720 and the outdoor unit 724. The air conditioner can receive power from a commercial power supply and can use power stored in the secondary battery 723. Particularly in the case where the secondary batteries 723 are provided in both the indoor unit 720 and the outdoor unit 724, the air conditioner can be utilized with use of the secondary battery 723 of one embodiment of the present invention as an uninterruptible power supply even when power cannot be supplied from a commercial power supply due to power failure or the like.

Although the split-type air conditioner including the indoor unit and the outdoor unit is shown in FIG. 14 as an example, the secondary battery of one embodiment of the present invention can be used in an air conditioner in which the function of an indoor unit and the function of an outdoor unit are integrated in one housing.

In FIG. 14, an electric refrigerator-freezer 730 is an example of an electrical appliance including a secondary battery 734 of one embodiment of the present invention. Specifically, the electric refrigerator-freezer 730 includes a housing 731, a door 732 for the refrigerator, a door 733 for the freezer, the secondary battery 734, and the like. The secondary battery 734 is provided in the housing 731 in FIG. 14. The electric refrigerator-freezer 730 can receive power from a commercial power and can use power stored in the secondary battery 734. Thus, the electric refrigerator-freezer 730 can be utilized with use of the secondary battery 734 of one embodiment of the present invention as an uninterruptible power supply even when power cannot be supplied from a commercial power supply due to power failure or the like.

Note that among the electric appliances described above, a high-frequency heating devices such as a microwave oven and an electric device such as an electric rice cooker require high power in a short time. The tripping of a breaker of a commercial power supply in use of an electric appliance can be prevented by using the secondary battery of one embodiment of the present invention as an auxiliary power supply for supplying electric power which cannot be supplied enough by a commercial power supply.

Electric power is stored in the secondary battery in a time period when electric appliances are not used, particularly when the proportion of the amount of actually used electric power to the total amount of electric power that can be supplied from a commercial power supply source (such a proportion is referred to as a usage rate of electric power) is low, whereby the usage rate of electric power can be reduced in a time period other than the above time period. For example, in the case of the electric refrigerator-freezer 730, power is stored in the secondary battery 734 in the nighttime when the temperature is low and the door 732 for the refrigerator and the door 733 for the freezer are not opened and closed. Moreover, in daytime when the temperature is high and the door 732 for the refrigerator and the door 733 for the freezer are opened and closed, the secondary battery 734 is used as an auxiliary power supply; thus, the usage rate of power in daytime can be reduced.

This embodiment can be implemented in appropriate combination with the other embodiments.

### Embodiment 5

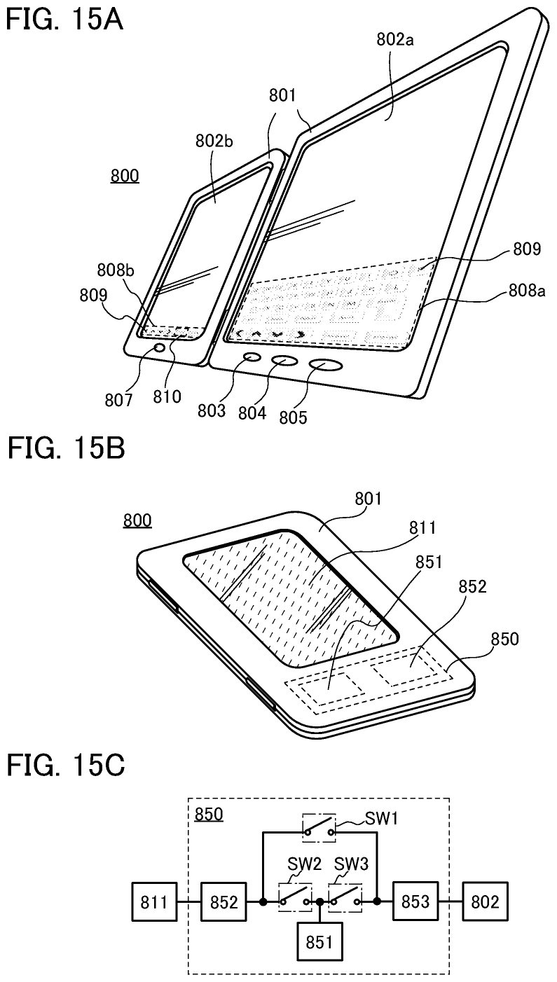

Next, a portable information terminal which is an example of the electrical appliance will be described with reference to FIG. 15.

FIG. 15A and FIG. 15B illustrate a tablet terminal 800 that can be folded in half FIG. 15A illustrates a state where the tablet terminal 800 is opened, and a housing 801, a display portion 802a, a display portion 802b, a switch 803 for switching display modes, a power switch 804, a switch 805 for switching to a power-saving mode, and an operation switch 807 are included.

Part of the display portion 802a can be a touch panel region 808a and data can be input when a displayed operation key 809 is touched. Note that the structure of the display portion 802a is not limited to the illustrated structure in which a half region in the display portion 802a has only a display function and the other half region has a touch panel function. The whole region in the display portion 802a may have a touch panel function. For example, keyboard buttons can be displayed on the entire display portion 802a to be used as a touch panel, and the display portion 802b can be used as a display screen.

Also in the display portion 802b, as in the display portion 802a, part of the display portion 802b can be a touch panel region 808b. A switching button 810 for showing/hiding a keyboard of the touch panel is touched with a finger, a stylus, or the like, so that keyboard buttons can be displayed on the display portion 802b.

Moreover, touch input can be performed in the touch panel region 808a and the touch panel region 808b at the same time.

The switch 803 for switching display modes can select the switching of the orientations of display between portrait display, landscape display, and the like, the switching between monochrome display and color display, and the like. The switch 805 for switching to a power-saving mode can control display luminance to be optimal in accordance with the amount of external light in use of the tablet terminal which is detected by an optical sensor incorporated in the tablet terminal. Another detection device including, for example, a sensor for detecting inclination, such as a gyroscope sensor or an acceleration sensor, may be incorporated in the tablet terminal, in addition to the optical sensor.

Note that FIG. 15A illustrates an example in which the display portion 802a and the display portion 802b have the same display area; however, without limitation thereon, one of the display portions may be different from the other display portion in size and display quality. For example, one of the display panels may display higher definition images than the other.

FIG. 15B illustrates a closed state, and the tablet terminal 800 includes the housing 801, a solar cell 811, a charge-discharge control circuit 850, a battery 851, and a DC-DC converter 852. In FIG. 15B, a structure including the battery 851 and the DC-DC converter 852 is illustrated as an example of the charge-discharge control circuit 850, and the secondary battery described in any of the above embodiments is included as the battery 851.

Since the tablet terminal 800 can be folded in half, the housing 801 can be closed when the tablet terminal is not used. Thus, the display portion 802a and the display portion 802b can be protected; thus, the tablet terminal 800 which has excellent durability and excellent reliability also in terms of long-term use can be provided.

The tablet terminal illustrated in FIG. 15A and FIG. 15B can also have a function of displaying various kinds of information (a still image, a moving image, a text image, and the like), a function of displaying a calendar, a date, the time, or the like on the display portion, a touch-input function of operating or editing data displayed on the display portion by touch input, a function of controlling processing by various kinds of software (programs), and the like.

The solar cell 811 provided on a surface of the tablet terminal can supply power to the touch panel, the display portion, a video signal processing portion, or the like. Note that the solar cell 811 can be provided on one surface or both surfaces of the housing 801, and it is possible to employ a structure where the battery 851 is charged efficiently. When the secondary battery of one embodiment of the present invention is used as the battery 851, there is an advantage such as a reduction in size.

The structure and the operation of the charge-discharge control circuit 850 illustrated in FIG. 15B will be described with reference to a block diagram in FIG. 15C. The solar cell 811, the battery 851, the DC-DC converter 852, a converter 853, switches SW1 to SW3, and the display portion 802 are illustrated in FIG. 15C, and the battery 851, the DC-DC converter 852, the converter 853, and the switches SW1 to SW3 correspond to the charge-discharge control circuit 850 illustrated in FIG. 15B.

First, an example of the operation in the case where power is generated by the solar cell 811 using external light is described. The voltage of power generated by the solar cell is raised or lowered by the DC-DC converter 852 so that the power has a voltage for charging the battery 851. Then, when the power from the solar cell 811 is used for the operation of the display portion 802, the switch SW1 is turned on and the voltage of the power is raised or lowered by the converter 853 so as to be a voltage needed for the display portion 802. In addition, when display on the display portion 802 is not performed, the switch SW1 is turned off and the switch SW2 is turned on so that the battery 851 may be charged.

Note that the solar cell 811 is described as an example of a power generation means; however, without limitation thereon, the battery 851 may be charged using another power generation means such as a piezoelectric element or a thermoelectric conversion element (Peltier element). For example, the charge may be performed with a non-contact power transmission module that performs charge by transmitting and receiving power wirelessly (without contact), or with a combination of other charge units.

It is needless to say that one embodiment of the present invention is not limited to the electrical appliance illustrated in FIG. 15 as long as the secondary battery described in any of the above embodiments is included.

This embodiment can be implemented in appropriate combination with the other embodiments.

### Embodiment 6

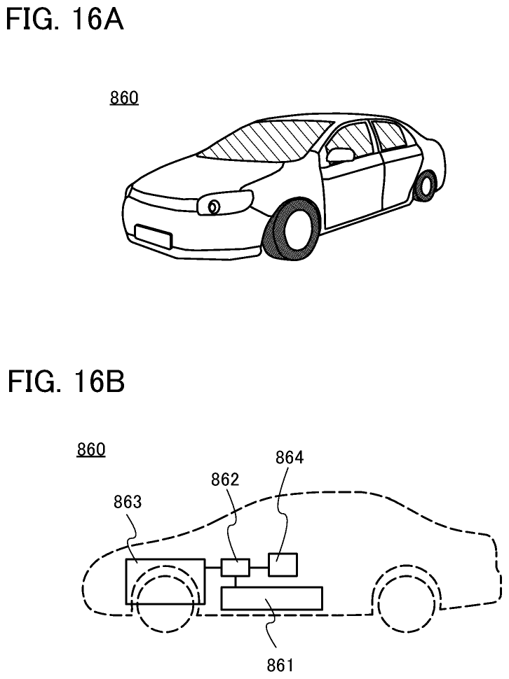

An example of the moving object that is an example of electric devices will be described with reference to FIG. 16.

The secondary battery described in any of the above embodiments can be used as a control battery. The control battery can be charged by electric power supply from the outside using a plug-in technique or contactless power feeding. Note that in the case where the moving object is an electric railway vehicle, the electric railway vehicle can be charged by power supply from an overhead cable or a conductor rail.

FIG. 16A and FIG. 16B illustrate an example of an electric vehicle. An electric vehicle 860 is equipped with a battery 861. The output of the electric power of the battery 861 is adjusted by a control circuit 862 and the electric power is supplied to a driving device 863. The control circuit 862 is controlled by a processing unit 864 including a ROM, a RAM, a CPU, or the like which is not illustrated.

The driving device 863 includes a DC motor or an AC motor alone or a motor in combination with an internal-combustion engine. The processing unit 864 outputs a control signal to the control circuit 862 based on input data such as data of operation (e.g., acceleration, deceleration, or stop) by a driver or data during driving (e.g., data on an upgrade or a downgrade, or data on a load on a driving wheel) of the electric vehicle 860. The control circuit 862 adjusts the electric energy supplied from the battery 861 in accordance with the control signal of the processing unit 864 to control the output of the driving device 863. In the case where the AC motor is mounted, although not illustrated, an inverter that converts a direct current into an alternate current is also incorporated.

The battery 861 can be charged by electric power supply from the outside using a plug-in technique. For example, the battery 861 is charged through a power plug from a commercial power supply. Charging can be performed by converting power into a DC constant voltage having a constant voltage value through a converter such as an AC/DC converter. Providing the secondary battery of one embodiment of the present invention as the battery 861 can contribute to an increase in the capacity of the battery or the like, so that convenience can be improved. When the battery 861 itself can be made compact and lightweight as a result of the improvement of the characteristics of the battery 861, it contributes to a reduction in the weight of the vehicle, and thus fuel efficiency can be increased.

It is needless to say that one embodiment of the present invention is not limited to the electronic device described above as long as the secondary battery of one embodiment of the present invention is included.

This embodiment can be implemented in appropriate combination with the other embodiments.

### Embodiment 7

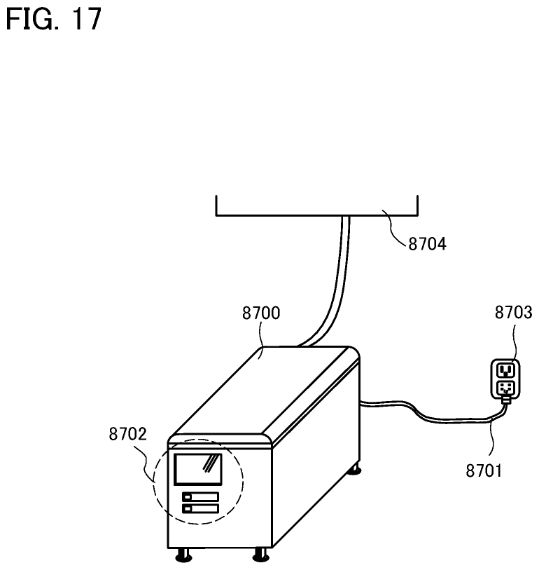

In this embodiment, an example of an uninterruptible power supply is described. An uninterruptible power supply 8700 illustrated in FIG. 17 includes at least a secondary battery, a protection circuit, a charging control circuit and a neural network portion inside, and may also include a mechanism for performing communication with or without a wire, a display panel 8702 for displaying the operating state and the like, for example.

A power cord 8701 of the uninterruptible power supply 8700 is electrically connected to a system power supply 8703. The uninterruptible power supply 8700 is electrically connected to precision equipment 8704. The precision equipment 8704 indicates, for example, a server device that should be prevented from being shut down. In the uninterruptible power supply 8700, a plurality of secondary batteries are connected in series or in parallel to achieve a desired voltage (for example, 80 V or more, 100 V, or 200 V).

A secondary battery of one embodiment of the present invention can be used as a secondary battery.

The degradation of the uninterruptible power supply 8700 is affected by various factors. In the case where the user installs the uninterruptible power supply 8700 inside or outside of the room, the degradation is also affected by the size of the room for installation, the room temperature, change in the temperature of the installation environment, and the like.

According to this embodiment, degradation prediction by an AI (AI: Artificial Intelligence) can be performed periodically on the secondary battery of the uninterruptible power supply 8700 and a user can determine the replacement timing of the battery on the basis of the result.

Furthermore, data obtained periodically is input to the neural network portion to perform learning and a feature value is extracted by operation in the neural network processing, so that the state of the secondary battery is analyzed more accurately.

For example, neural network processing can be used for the prediction and detection of an occurrence of abnormality of the secondary battery (specifically, an occurrence of a micro short circuit).

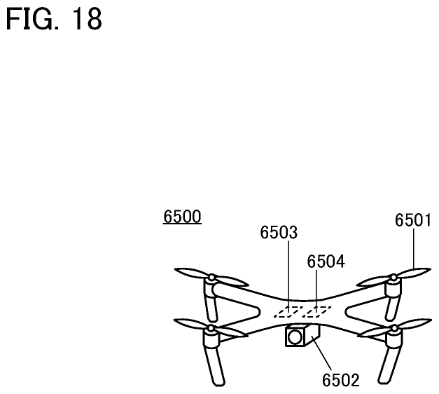

FIG. 18 illustrates an example of a flying object. A flying object 6500 illustrated in FIG. 18 includes propellers 6501, a camera 6502, a battery 6503, and the like and has a function of flying autonomously. The secondary battery of one embodiment of the present invention can be used as the battery 6503. Since the secondary battery of one embodiment of the present invention has high energy density, the driving period of the flying object 6500 can be longer. Moreover, since the secondary battery of one embodiment of the present invention has excellent output characteristics and accordingly is suitable for the time when high output characteristics are required, e.g., at the time of accelerating the flying object 6500.

For example, image data taken by the camera 6502 is stored in an electronic component 6504. The electronic component 6504 can analyze the image data to detect whether there is an obstacle in the way of the movement. As the camera 6502, a plurality of kinds of imaging devices may be used.

This embodiment can be implemented in appropriate combination with the other embodiments.

### REFERENCE NUMERALS

100: NMP, 101: RGO, 102: graphene oxide, 200: electrode, 201: current collector, 202: active material layer, 203: active material, 204: graphene, 207: carbon-containing compound, 208: aggregate, 209: aggregate, 211: path length, 212: protrusion portion, 213: length of one side, 214: graphene oxide, 221: monomer, 222: binding agent, 223: solvent, 224: sample, 225: sample, 226: solution, 227: electrode, 228: electrode, 231a: layer, 231b: layer, 300: secondary battery, 301: positive electrode can, 302: negative electrode can, 303: gasket, 304: positive electrode, 305: positive electrode current collector, 306: positive electrode active material layer, 307: negative electrode, 308: negative electrode current collector, 309: negative electrode active material layer, 310: separator, 500: secondary battery, 501: positive electrode current collector, 502: positive electrode active material layer, 503: positive electrode, 504: negative electrode current collector, 505: negative electrode active material layer, 506: negative electrode, 507: separator, 508: electrolyte solution, 509: exterior body, 600: secondary battery, 601: positive electrode cap, 602: battery can, 603: positive electrode terminal, 604: positive electrode, 605: separator, 606: negative electrode, 607: negative electrode terminal, 608: insulating plate, 609: insulating plate, 611: PTC element, 612: safety valve mechanism, 700: display device, 701: housing, 702: display portion, 703: speaker portion, 704: secondary battery, 710: lighting device, 711: housing, 712: light source, 713: secondary battery, 714: ceiling, 715: sidewall, 716: floor, 717: window, 720: indoor unit, 721: housing, 722: air outlet, 723: secondary battery, 724: outdoor unit, 730: electric refrigerator-freezer, 731: housing, 732: door for refrigerator, 733: door for freezer, 734: secondary battery, 800: tablet terminal, 801: housing, 802: display portion, 802a: display portion, 802b: display portion, 803: switch, 804: power switch, 805: switch, 807: operation switch, 808a: region, 808b: region, 809: operation key, 810: button, 811: solar cell, 850: charge-discharge control circuit, 851: battery, 852: DC-DC converter, 853: converter, 860: electric vehicle, 861: battery, 862: control circuit, 863: driving device, 864: processing unit, 8700: uninterruptible power supply, 8701: power cord, 8702: display panel, 8703: system power supply, 8704: precision equipment,

1. An electrode comprising:
a current collector; and
an active material layer,
wherein the active material layer comprises a plurality of particulate active materials and a plurality of fibrous carbon-containing compounds,
wherein each of the plurality of fibrous carbon-containing compounds is a high molecular compound, and
wherein a monomer of the high molecular compound is at least one selected from the group consisting of thiophene, benzene, pyrrole, aniline, phenol, phthalocyanine, furan, azulene, and a derivative of any of these.

2. The electrode according to claim 1, wherein an average diameter of the plurality of fibrous carbon-containing compounds is greater than or equal to 0.01 μm and less than or equal to 50 μm.

3. The electrode according to claim 1, wherein the plurality of fibrous carbon-containing compounds have a net-like structure reaching a surface of the active material layer.

4. The electrode according to claim 3,
wherein the active material layer is provided over the current collector, and
wherein the net-like structure is in contact with a surface of the current collector.

5. The electrode according to claim 1, wherein the active material is a lithium-containing composite oxide having an olivine crystal structure.

6. The electrode according to claim 1, wherein an average diameter of primary particles of the active material is greater than or equal to 50 nm and less than or equal to 500 nm.

7. An electrode comprising:
a current collector; and
an active material layer,
wherein the active material layer comprises a plurality of particulate active materials and a plurality of fibrous carbon-containing compounds,
wherein each of the plurality of fibrous carbon-containing compounds is a high molecular compound,
wherein a monomer of the high molecular compound is at least one selected from the group consisting of thiophene, benzene, pyrrole, aniline, phenol, phthalocyanine, furan, azulene, and a derivative of any of these, and
wherein the plurality of fibrous carbon-containing compounds are in contact with each other to form a path penetrating the active material layer.

8. The electrode according to claim 7, wherein an average diameter of the plurality of fibrous carbon-containing compounds is greater than or equal to 0.01 μm and less than or equal to 50 μm.

9. The electrode according to claim 7, wherein the active material is a lithium-containing composite oxide having an olivine crystal structure.

10. The electrode according to claim 7, wherein an average diameter of primary particles of the active material is greater than or equal to 50 nm and less than or equal to 500 nm.

11. An electrode comprising:
a current collector; and
an active material layer,
wherein the active material layer comprises a first aggregate of active materials, a second aggregate of active materials, and a plurality of fibrous carbon-containing compounds,
wherein each of the first aggregate and the second aggregate comprises a plurality of primary particles,
wherein each of the plurality of fibrous carbon-containing compounds is a high molecular compound, and
wherein a monomer of the high molecular compound is at least one selected from the group consisting of thiophene, benzene, pyrrole, aniline, phenol, phthalocyanine, furan, azulene, and a derivative of any of these.

12. The electrode according to claim 11, wherein an average diameter of the plurality of fibrous carbon-containing compounds is greater than or equal to 0.01 μm and less than or equal to 50 μm.

13. The electrode according to claim 11, wherein the plurality of fibrous carbon-containing compounds have a net-like structure reaching a surface of the active material layer.

14. The electrode according to claim 13,
wherein the active material layer is provided over the current collector, and
wherein the net-like structure is in contact with a surface of the current collector.

15. The electrode according to claim 11, wherein the active material is a lithium-containing composite oxide having an olivine crystal structure.

16. The electrode according to claim 11, wherein an average diameter of primary particles of the active material is greater than or equal to 50 nm and less than or equal to 500 nm.

17. A secondary battery comprising the electrode according to claim 1.

18. An electronic device comprising the secondary battery according to claim 17.

19. A secondary battery comprising the electrode according to claim 11.

20. An electronic device comprising the secondary battery according to claim 19.
